(19) United States
(12) Patent Application Publication
(10) Pub. No.: US 2025/0358207 A1
(43) Pub. Date: Nov. 20, 2025

(54) DOWNLINK AND UPLINK RADIO COMMUNICATION ASPECTS

(71) Applicant: QUALCOMM Incorporated, San Diego, CA (US)

(72) Inventors: Sitaramanjaneyulu KANAMARLAPUDI, San Diego, CA (US); Arnaud MEYLAN, San Diego, CA (US); Vamsi DOKKU, San Diego, CA (US)

(21) Appl. No.: 19/209,686

(22) Filed: May 15, 2025

Related U.S. Application Data
(60) Provisional application No. 63/649,313, filed on May 17, 2024.
(60) Provisional application No. 63/649,319, filed on May 17, 2024.

(51) Int. Cl. H04L 43/0852; H04W 28/02; H04W 76/15

(52) U.S. Cl. CPC H04L 43/0852; H04W 28/0284; H04W 76/15

(57) ABSTRACT

Aspects of the disclosure are directed to downlink radio layer and uplink radio layer aspects of communication. Specifically, communication via low latency, low loss, and scalable throughput (LAS).

### CROSS REFERENCE TO RELATED APPLICATIONS

The present application for patent claims the benefit of U.S. Provisional Application No. 63/649,319, entitled “DOWNLINK RADIO COMMUNICATION ASPECTS,” filed May 17, 2024, and U.S. Provisional Application No. 63/649,313, entitled “UPLINK RADIO COMMUNICATION ASPECTS,” filed May 17, 2024, each of which is assigned to the assignee hereof and expressly incorporated herein by reference in its entirety.

### BACKGROUND

### Technical Field

The present disclosure generally relates to communication systems, and more particularly, to downlink and uplink communications between a user equipment (UE) and a radio access network (RAN).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects are directed to an apparatus for wireless communication comprising: one or more memories, individually or in combination, having instructions, and one or more processors, individually or in combination, configured to execute the instructions. In some examples, the one or more processors are configured to detect latency associated with a packet queued at the apparatus. In some examples, the one or more processors are configured to set a bit associated with the packet, wherein the bit is set to indicate the detected latency.

Aspects are directed to an apparatus for wireless communication comprising: one or more memories, individually or in combination, having instructions, and one or more processors, individually or in combination, configured to execute the instructions. In some examples, the one or more processors are configured to detect latency associated with a packet queued at the apparatus, the packet configured to be output for transmission via a first link. In some examples, the one or more processors are configured to override an uplink data split threshold value associated with the packet. In some examples, the one or more processors are configured to output the packet via a second link after the override.

Aspects are directed to an apparatus for wireless communication comprising: one or more memories, individually or in combination, having instructions, and one or more processors, individually or in combination, configured to execute the instructions. In some examples, the one or more processors are configured to detect latency associated with a packet queued at the apparatus. In some examples, the one or more processors are configured to set a bit associated with the packet, wherein the bit is set to indicate the detected latency. In some examples, the one or more processors are configured to override, based on at least one of the detected latency or the bit being set, at least one of: (i) an uplink data split threshold value associated with the packet, or (ii) a packet data convergence protocol (PDCP) discard timer associated with the packet.

Aspects are directed to a method for wireless communication. In some examples, the method includes detecting latency associated with a packet queued at the apparatus. In some examples, the method includes setting a bit associated with the packet, wherein the bit is set to indicate the detected latency.

Aspects are directed to a method for wireless communication. In some examples, the method includes detecting latency associated with a packet queued at the apparatus, the packet configured to be output for transmission via a first link. In some examples, the method includes overriding an uplink data split threshold value associated with the packet. In some examples, the method includes outputting the packet via a second link after the override.

Aspects are directed to a method for wireless communication. In some examples, the method includes detecting latency associated with a packet queued at the apparatus. In some examples, the method includes setting a bit associated with the packet, wherein the bit is set to indicate the detected latency. In some examples, the method includes overriding, based on at least one of the detected latency or the bit being set, at least one of: (i) an uplink data split threshold value associated with the packet, or (ii) a packet data convergence protocol (PDCP) discard timer associated with the packet.

Aspects are directed to an apparatus. In some examples, the apparatus includes means for detecting latency associated with a packet queued at the apparatus. In some examples, the apparatus includes means for setting a bit associated with the packet, wherein the bit is set to indicate the detected latency.

Aspects are directed to an apparatus. In some examples, the apparatus includes means for detecting latency associated with a packet queued at the apparatus, the packet configured to be output for transmission via a first link. In some examples, the apparatus includes means for overriding an uplink data split threshold value associated with the packet. In some examples, the apparatus includes means for outputting the packet via a second link after the override.

Aspects are directed to an apparatus. In some examples, the apparatus includes means for detecting latency associated with a packet queued at the apparatus. In some examples, the apparatus includes means for setting a bit associated with the packet, wherein the bit is set to indicate the detected latency. In some examples, the apparatus includes means for overriding, based on at least one of the detected latency or the bit being set, at least one of: (i) an uplink data split threshold value associated with the packet, or (ii) a packet data convergence protocol (PDCP) discard timer associated with the packet.

Aspects are directed to a non-transitory computer-readable medium comprising instructions that, when executed by a wireless node, cause the wireless node to perform a method. In some examples, the method includes detecting latency associated with a packet queued at the wireless node. In some examples, the method includes setting a bit associated with the packet, wherein the bit is set to indicate the detected latency.

Aspects are directed to a non-transitory computer-readable medium comprising instructions that, when executed by a wireless node, cause the wireless node to perform a method. In some examples, the method includes detecting latency associated with a packet queued at the wireless node, the packet configured to be output for transmission via a first link. In some examples, the method includes overriding an uplink data split threshold value associated with the packet. In some examples, the method includes outputting the packet via a second link after the override.

Aspects are directed to a non-transitory computer-readable medium comprising instructions that, when executed by a wireless node, cause the wireless node to perform a method. In some examples, the method includes detecting latency associated with a packet queued at the wireless node. In some examples, the method includes setting a bit associated with the packet, wherein the bit is set to indicate the detected latency. In some examples, the method includes overriding, based on at least one of the detected latency or the bit being set, at least one of: (i) an uplink data split threshold value associated with the packet, or (ii) a packet data convergence protocol (PDCP) discard timer associated with the packet.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram illustrating an example of a layer 2 (L2) data flow.

FIG. 6 is a block diagram illustrating an example transmission control protocol (TCP) data flow.

FIG. 7 is a flowchart of a method of wireless communication.

FIG. 8 is a flowchart of a method of wireless communication.

FIG. 9 is a flowchart of a method of wireless communication.

FIG. 10 is a diagram illustrating an example of a hardware implementation for an example apparatus.

FIG. 11 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

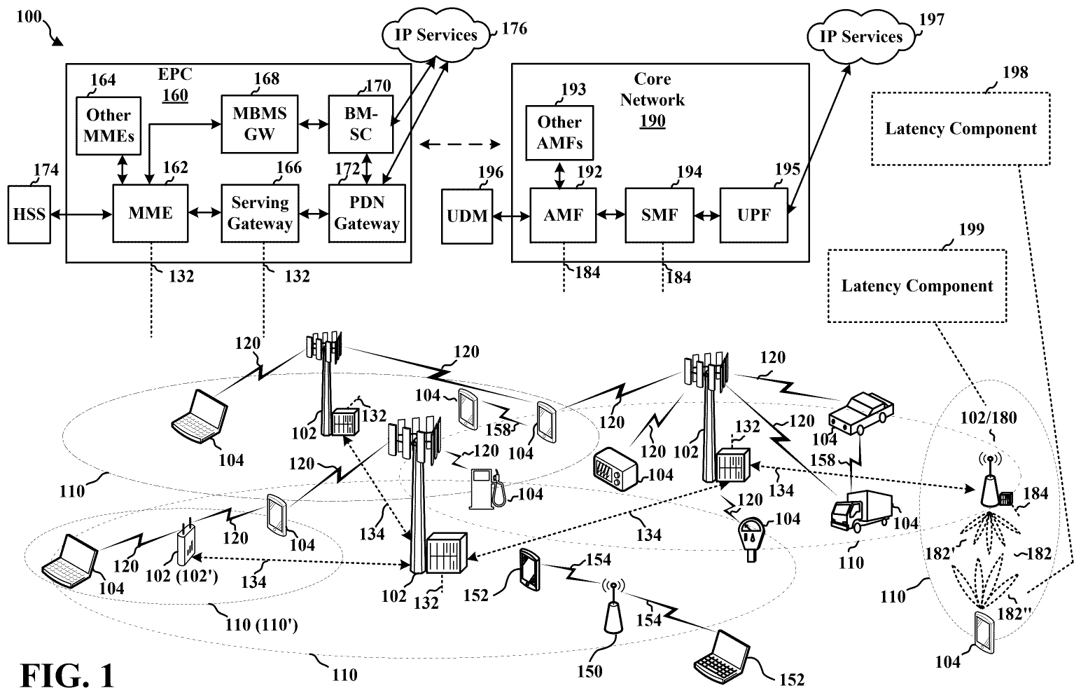

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

Referring again to FIG. 1, the UE 104 may include a latency component 198. As described in more detail elsewhere herein, the latency component 198 may be configured to detect latency associated with a packet queued at the apparatus, and set a bit associated with the packet, wherein the bit is set to indicate the detected latency. Additionally, or alternatively, the latency component 198 may perform one or more other operations described herein. For example, the latency component 198 may be further configured to modify a communication parameter based on at least one of the detected latency or the bit being set.

In certain aspects, the latency component 198 may be configured to: detect latency associated with a packet queued at the apparatus; and set a bit associated with the packet, wherein the bit is set to indicate the detected latency.

In certain aspects, the latency component 198 may be configured to: detect latency associated with a packet queued at the apparatus, the packet configured to be output for transmission via a first link; override an uplink data split threshold value associated with the packet; and output the packet via a second link after the override.

In certain aspects, the latency component 198 may be configured to: detect latency associated with a packet queued at the wireless node; set a bit associated with the packet, wherein the bit is set to indicate the detected latency; and override, based on at least one of the detected latency or the bit being set, at least one of: (i) an uplink data split threshold value associated with the packet, or (ii) a packet data convergence protocol (PDCP) discard timer associated with the packet.

The base station 102/180 may include a latency component 199. As described in more detail elsewhere herein, the latency component 199 may be configured to detect latency associated with a packet queued at the apparatus, and set a bit associated with the packet, wherein the bit is set to indicate the detected latency. Additionally, or alternatively, the latency component 199 may perform one or more other operations described herein. For example, the latency component 199 may be further configured to modify a communication parameter based on at least one of the detected latency or the bit being set.

In certain aspects, the latency component 199 may be configured to: detect latency associated with a packet queued at the apparatus; and set a bit associated with the packet, wherein the bit is set to indicate the detected latency.

In certain aspects, the latency component 199 may be configured to: detect latency associated with a packet queued at the apparatus, the packet configured to be output for transmission via a first link; override an uplink data split threshold value associated with the packet; and output the packet via a second link after the override.

In certain aspects, the latency component 199 may be configured to: detect latency associated with a packet queued at the wireless node; set a bit associated with the packet, wherein the bit is set to indicate the detected latency; and override, based on at least one of the detected latency or the bit being set, at least one of: (i) an uplink data split threshold value associated with the packet, or (ii) a packet data convergence protocol (PDCP) discard timer associated with the packet.

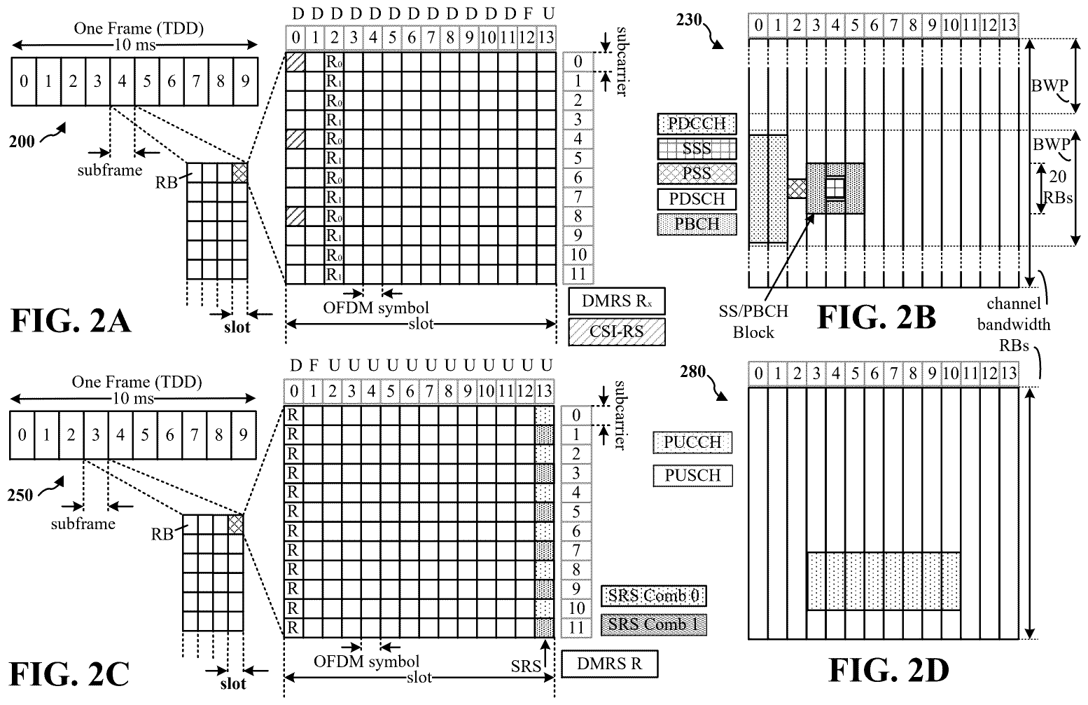

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

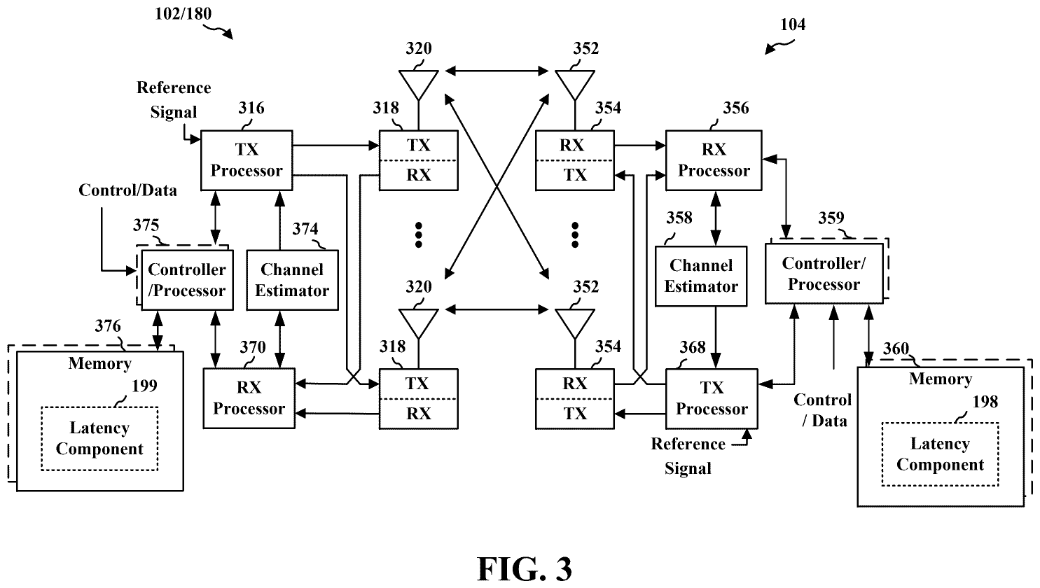

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, onto mapping physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

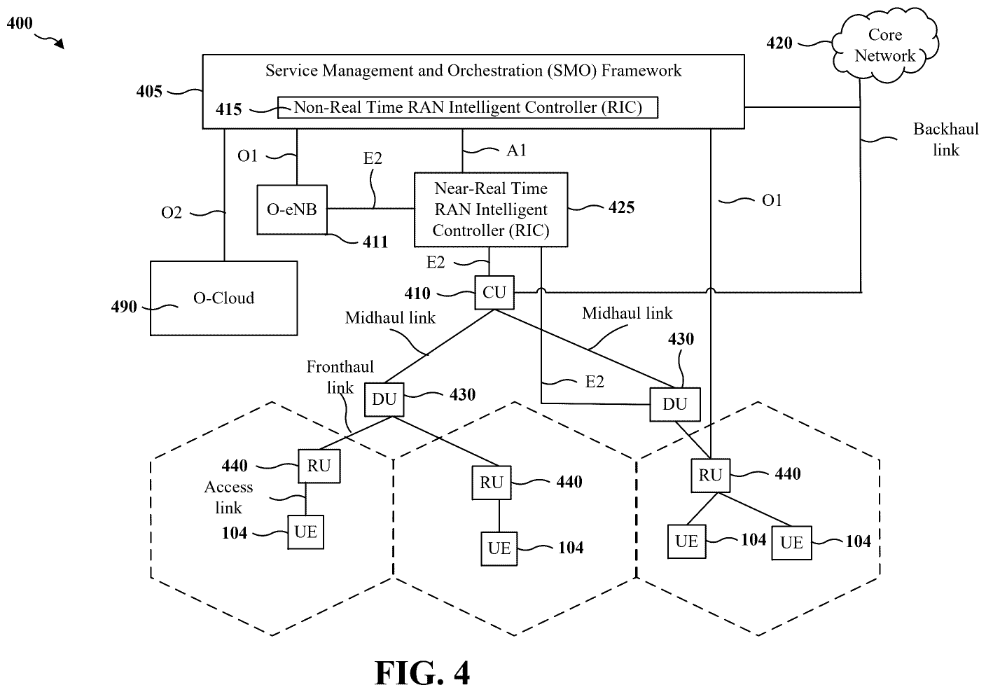

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUS 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include one or more receivers, one or more transmitters or transceivers (such as one or more radio frequency (RF) transceivers), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via 01) or via creation of RAN management policies (such as A1 policies).

### Examples of Low-Latency, Low-Loss, Scalable Throughput (L4S) Communications

The L4S protocol is a network technology designed to enhance the performance of internet traffic by reducing latency and packet loss while maintaining high throughput. It achieves this by using a more advanced congestion control mechanism that allows for faster and more efficient data transmission. Unlike traditional protocols, which can experience significant delays and packet loss during high traffic periods, L4S is configured to handle congestion more gracefully, ensuring smoother and more responsive internet experiences. This is particularly beneficial for applications that require real-time data transmission, such as online gaming, video conferencing, and virtual reality.

The key difference between L4S and non-L4S protocols lies in their approach to managing network congestion. Non-L4S protocols typically use methods like TCP's congestion control, which can lead to increased latency and packet loss as the network becomes congested. These traditional methods often involve slowing down data transmission to prevent congestion, which can degrade performance. In contrast, L4S uses a more sophisticated approach that allows for continuous data flow even under congested conditions, minimizing delays and packet loss. This is achieved through techniques like explicit congestion notification (ECN) marking, which provides feedback to the sender about the network's state, allowing for dynamic adjustments to the transmission rate. As a result, L4S can deliver a more consistent and reliable internet experience, especially in environments where low latency is crucial.

Conventional data requirements for user experience may be based on well-defined key performance indicators (KPI) linked to throughput, latency and packet loss. Transmission control protocol (TCP) is one of the main protocols in the internet protocol suite, and it sits at the same layer as the internet Protocol (IP), together often referred to as TCP/IP. TCP congestion algorithms may handle scaling aspects of traffic based on throughput, latency and/or packet loss, and variants of these algorithms may be configured to address different segments and market needs based on traffic patterns and topology of a given network.

Quick UDP internet connections (QUIC) relates to a transport layer protocol developed to improve the performance of web applications by decreasing latency compared to that of TCP. In some examples, QUIC achieves faster connection establishment by introducing a connection identifier and combining the connection and security handshakes into a single step, which reduces the time it takes to establish a secure connection. It's built on top of user datagram protocol (UDP) instead of TCP, which allows it to bypass some of the limitations of TCP. QUIC also offers improved congestion control, forward error correction, and handling of packet loss, all of which can contribute to better performance for real-time streaming applications and web browsing. Thus, QUIC addresses head-of-line blocking (HOLB) aspects to improve throughput and packet loss. However, despite these advantages, latency may continue to be a challenge.

For example, with relatively higher bandwidth links both at backhaul and on radio networks to address specific link issues, latency and packet loss continue to present problems for communications due to the many various application traffic requirements and despite attempts by congestion algorithms to adapt. In some examples, latency may negatively affect round trip time (RTT) and result in packet drop due to buffer buildup at some link/point in an end-to-end (E2E) network between, for example, an application server or IP service and a user.

With the addition of extended reality (XR) type verticals (e.g., technologies and applications that use XR technologies), where latency is a top priority for an enhanced and immersive user experience, there is a need to develop techniques for reducing latency. For example, haptic traffic (e.g., data and signals associated with tactile sensations) has latency requirements typically being sub-5 ms (relative to video gaming latency requirements of sub-30 ms). Reducing latency in time-critical, time-sensitive networking (TSN) is also a priority in, for example, industrial implementations and mixed-traffic communications (e.g., Zoom call and simultaneous file upload/download as part of applications usage) and other scenarios that include differential behavior of traffic characteristics.

In summary, varying traffic loading and buffer management issues can result in increased queuing delay or packet loss which existing TCP congestion algorithms often fail to address. For example, existing TCP congestion algorithms are often incapable of traffic loading and buffer management in a manner that account for IP traffic being routed through various intermittent nodes. To address the short comings of existing TCP congestion algorithms, L4S protocol may be implemented with some variations to the architecture of the TCP protocol and congestion management techniques, with fallback to a mechanism to coexist rather that use completely different protocol.

In certain aspects, the L4S protocol may be configured to mark packets with ECN info at a link level if some buffer build up or congestion in the link is detected. This marking enables a receiver to determine an interval and/or a quantity of packets that are affected by queuing issues, and provide the feedback to the transmitter via “aggregated ECN” info to adapt the rate at the transmitter.

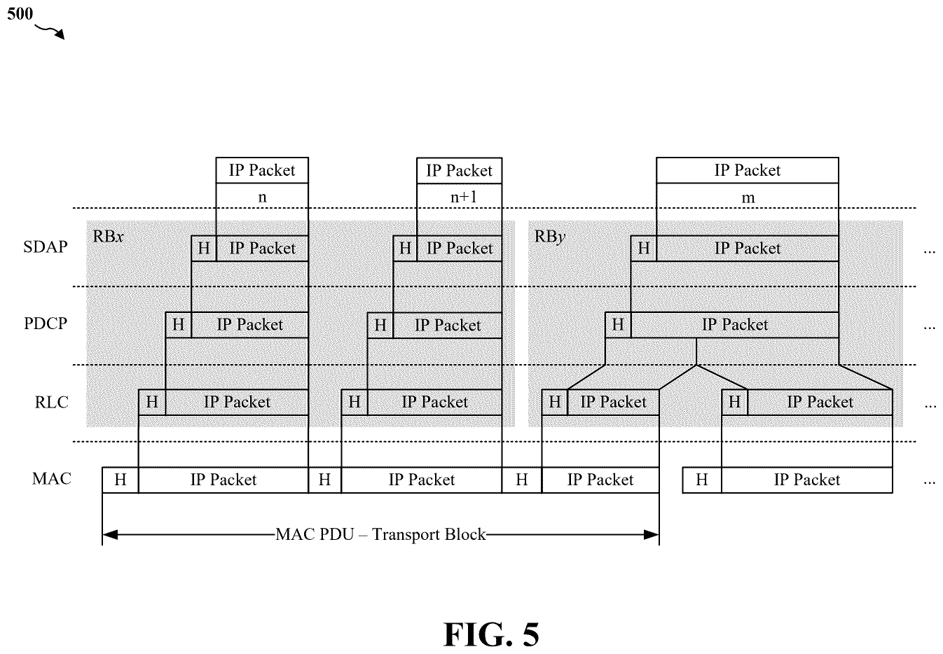

FIG. 5 is a block diagram illustrating an example of a layer 2 (L2) data flow. As illustrated, resource blocks (RBs) form a foundation of an L2 data flow, which are the smallest units of data transmission in wireless communications. Central to the data flow are IP packets, which are units of data containing routing information and payloads. These packets are processed through various layers to reach their destination. For example, the IP packets may be routed through a service data adaptation protocol (SDAP) layer which maps the IP packets to appropriate quality of service (QOS) flows, ensuring data is transmitted with the correct priority for different applications.

The packet data convergence protocol (PDCP) layer handles compression and encryption, maintaining data integrity and security by reducing overhead and protecting data from unauthorized access. It also manages retransmissions in case of packet loss. The radio link control (RLC) layer is configured to handle error correction and data segmentation, breaking down large packets into smaller segments for transmission and reassembling them at the receiving end, while also managing retransmissions and error correction. Finally, the medium access control (MAC) layer controls access to the physical transmission medium, scheduling data transmission, managing resource allocation, and handling collision avoidance to ensure efficient data transmission and resource sharing among users. Together, these layers and components form a complex system that facilitates the seamless delivery of data across wireless networks. In terms of data flow, the data goes through these protocols in the sequence SDAP->PDCP->RLC->MAC before being transmitted over the physical layer.

Internet protocol (IP) operates at a higher layer in the network stack, specifically at the network layer (e.g., layer 3) of the OSI model. IP is responsible for delivering packets from a source device to a destination device based on IP addresses in the packet headers (illustrated as “H”). In a 5G NR network, the IP packets are passed down from the network layer to a transport layer (e.g., layer 4), where protocols like TCP or UDP operate. After that, they are passed down to a data link layer (e.g., layer 2), where the above-mentioned protocols (SDAP, PDCP, RLC, MAC) function.

The PDCP at layer 2 is the layer that directly interacts with IP packets. It receives the IP packets from the upper layer, performs operations like header compression to reduce the size of the IP headers, and then passes them to the lower layers for transmission. It should be noted, low latency is not provided by the network; rather, low latency may be a result of scalable congestion controllers used by LAS senders. Such controllers may use ECN protocol by signaling the start of queue growth immediately, without the smoothing delay typical of conventional active queue management (AQM). Because ECN support is essential for L4S, wireless nodes may use an ECN field to allow the network to identify which packets are L4S and which are not. A transmitting device may distinguish L4S and non-L4S packets with an identifier so that the network can classify them and treat them according to their unique requirements.

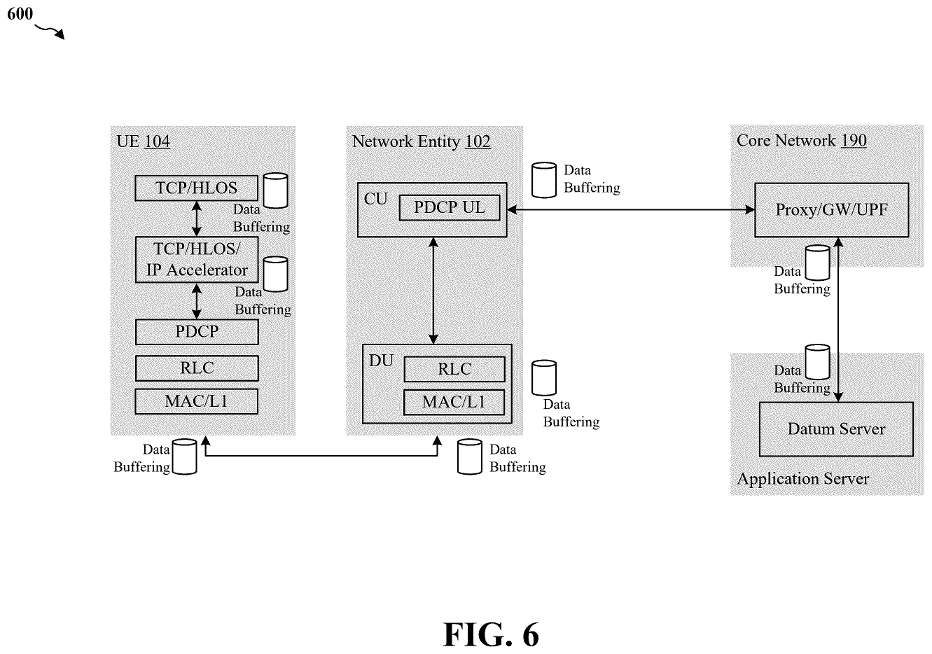

However, latency problems still exist with L4S protocol. While the L4S protocol addresses IP Data transmission as well as congestion aspects to improve traffic flow KPIs in an IP Network, latency issues associated with queueing delay still exist within the radio environment, for example in RAN network architecture and UE architecture. FIG. 6 is a block diagram illustrating an example TCP data flow 600. As illustrated, various data buffers exist throughout the E2E pipeline. Such buffering between the RAN node(s) and UE may be improved to reduce latency.

Regarding downlink communications: Application Server to UPF in the radio network and from UPF to a network entity (e.g., DU/CU) may be IP-based links without any flow control. Thus, data may move through these links based on routing rules and link capacity with a relatively low expectation that packets will be dropped. As an IP Packet enters into the network entity, the IP packet may move through various radio protocols. However, the IP packet may not be modified within radio protocol layers even to address L4S protocol aspects.

Regarding uplink communications: an application operating on a UE may transmit data to a UE modem via various interconnect mechanisms (e.g., Shared memory, USB, PCIe, HW accelerators etc.). Once data enters a PDCP Queue, it may be reported as part of a Data Volume reporting via a MAC Buffer Status Report (BSR) transmitted to a network request for UL Grant. In some examples, it may be reported via a scheduling request (SR) procedure or random-access channel (RACH) procedure, based on the UE state.

In some examples, a PDCP layer within the CU may move a packet over the NR-U link to the DU for RLC level protocol handling and subsequent MAC scheduling to transmit over-the-air (OTA). NR-U link works based on the GTP-U with “status-retransmission” to ensure all the packets are successfully received at DU. There can be additional delays and packet loss/recovery characteristics (e.g., RLC ARQ, HARQ ReTx) which impact the overall latency from an application data perspective.

For example, several scenarios in downlink the NW to the UE may contribute to such latency: First, there may be no flow control on the NG-U link. As such, the UPF may push as much data as much as possible to CU via the NG-U link when the link is active. In some examples, because a UE buffer is under RAN policy, downlink packets can be discarded at the UE due to a buffer full event. Second, flow control may be used on the NR-U link, which controls how much data can arrive from CU to DU, based on the DL Scheduling and buffering policies per UE. Third, there can be large amount of delay at MAC level at a network entity and/or UE due to scheduling delays, which can be due to a system level loading issue at RAN, policy-based delays, or due to UE channel conditions. Fourth, packet delays due to HARQ BLER which may result in multiple HARQs to recover and/or retransmit. Fifth, packet delays due to RLC ARQ retransmission and associated delays at PDCP reordering queue level. Sixth, packet delays due to Scheduling policy and operating radio conditions in terms of grant size, MCS and UE reported CSI information, etc.

Additionally, several scenarios in uplink from UE to NW may contribute to such latency: (1) UL Packet delays at PDCP level itself due to SR or RACH procedure latency based on the UE connection state and NW configuration. (2) UL Packet delays at BSR procedure latency to indicate the request to NW. (3) UL Packet delays due to UL Grant assignment from NW, based on scheduling policy. (4) UL Packet delays due to HARQ BLER resulting in multiple HARQs to recover. (5) UL Packet delays due to RLC ARQ resulting in retransmission (reTx) and associated delays at PDCP reordering queue level. (6) UL Packet delays due to Flow→RB mapping and associated LCP rules which are limiting the amount of data which can be transmitted from that LC based on priority and BSD/PBR etc. (7) UL Packet delays due to Scheduling policy and operating radio conditions in terms of Grant size, MCS and available Power Head Room etc. Also, (8) Network-side UL PDCP reordering delays. For instance, in a Dual Cell scenario, one primary leg may perform fine, while the secondary leg experiences delays, as a result the whole bearer experiences delay.

All these delays may result in latency due to packet loss based on: (i) various aspects of the buffering policy at NW/UE and its capabilities, and (ii) configuration parameters like PDCP discard timer from Tx side, PDCP reordering timer from Rx side, RLC ReTx/polling/status triggers, HARQ configuration as well as buffer overload policies may contribute to packet loss and latency. Moreover, because IP aspects of the packet cease or are removed after the PDCP PDU encoding (due to cipher/integrity aspects), even with the additional queueing latency issues identified, packets cannot be modified/marked with ECN to fulfill L4S.

Because cellular implementations typically use PDCP in-sequence delivery, there are different ways which may cause packets to experience delay: (i) on a given radio link, apart from the packets which are going through ReTx and experiencing higher latency, all other packets which are successfully received and waiting in the PDCP reordering queue will experience the additional latency (all the packets will experience worst case latency of the last packet reception to enable the in-sequence delivery or timer reordering expiry). These delays can be due to radio link level BLER or CC-level BLER or slot-level BLER or specific to MCS level. And (ii) in dual connected mode of operation (NR-DC/EN-DC), as different PDCP packets take different radio connections (LTE vs NR, FR1 vs FR2), associated additional delay/loss also can contribute for a greater number of packets being in the waiting mode at PDCP reordering level.

Thus, aspects of the disclosure are directed to techniques and methods for extending the L4S concepts to cellular radio architecture and addressing queuing delay and buffer handling aspects related to latency at both the UE and network entities. Such aspects are directed to enhancing E2E application level KPIs to improve the service level agreement (SLA) aspects of the application. Aspects of the disclosure are also directed to downlink radio aspects in modem access stratum between the UE and a network entity, and operations that may be performed at the modem to and other levels to reduce or eliminate delays.

### Examples of UE-Side Downlink Modem Aspects

Aspects are directed to radio protocol qualities of the end-to-end L4S concepts so that the L4S is capable of working in an improved manner in a radio environment. This may include determining, by the network entity and/or UE, when congestion happens and indicating the congestion in an IP header. This part is typically done by the routers in the IP protocol level, which is the expectation of the RFC. However, once a device gets into a PDCP packet, the IP domain qualities may be lost. Thus, even when the data is in the radio protocol, the congestion situation may be detected, and the ECN header marked to indicate congestion. The disclosure is directed to downlink radio protocol aspects in the modem. For example, radio protocol aspects may include the PDCP layer, the RLC layer, and MAC layers of the modem at the UE and network entity.

The UE modem may act as a concentration point, gathering flows from various hosts and clients. For example, when a UE is operated, multiple flows associated with multiple services and/or applications may exist. The different flows may be serviced differently based on the various subscriptions, sessions, bearers, priority, video protocols, etc. associated with corresponding flows.

In certain aspects, the UE may set ECN bits of a packet to indicate latency associated with that packet based on a downlink Reordering queue or RLC reassembly buffer build up in the modem. In one example, the network may transmit in-sequence packets 0, 1, 2, and 3 via a downlink to the UE, but the UE does not receive packet 0. Thus, packets 1-3 have been received and are buffered, but meanwhile packet 0 is going through an RLC retransmission process. Packets 1-3 may remain in buffer until packet 0 is received based on, for example, an in-sequence requirement at the PDCP reordering window. Accordingly, by the time the UE receives a retransmission of packet 0, packets 0-3 have been delayed for a period of time which affects the client application on the UE. Such delays may interrupt smooth communication of packets between RLC reception and client application reception with delays followed by bursts of packets.

Thus, in certain aspects, the modem may provide an application processor with an indication of such packet delay. The indication may include information about the specific packets, the length of the delay, a reason for the delay (e.g., in-sequence requirement, reordering, retransmission, etc.), and/or any other suitable parameter or metric associated with the flow of packets. In response, the application processor may set an ECN bit of one or more of packets 0-3.

Alternatively, the modem may provide the indication of packet delay to an interconnect (e.g., PCIe, USB, Ethernet, WLAN, SOC network on a chip, IP accelerator hardware (IPA HW), or to the PDCP layer. That is, the modem may trigger the interconnect or the PDCP layer to set ECN bits of the packets to indicate latency. For example, the PDCP layer (within the modem) may set the ECN bit of a packet when it is delivering the packet to the application processor (e.g., TCP/HLOS) after performing PDCP deciphering of the packets.

In some examples, the modem may provide the application processor, the interconnect, or the PDCP layer the indication if: the length of the delay, the number of packets causing the delay, or if the amount of data buffered and waiting on retransmission, satisfies a threshold condition. For example, the modem may be configured to provide the notification if 2 or more packets from a sequence of packets are delayed. Thus, if a single packet is delayed, the modem may refrain from providing the any notification for ECN marking. However, if two or more packets are delayed, the modem may provide the notification to the application processor, the interconnect, or the PDCP layer. In another example, if one or more packets of a sequence are buffered for 100 ms waiting for retransmission of another packet, the UE modem may refrain from providing the notification. However, if the one or more packets are buffered for 500 ms, then the modem may provide the notification.

In certain aspects, whether an ECN bit of a packet is set may be based on a downlink HARQ BLER or RLC ARQ which is associated with a detected delay of the packet. In a first example, the ECN bit of a packet in a PDCP downlink Queue (PDCP SDU=IP Packet) may be set based on HARQ BLER or based on HARQ BLER specific to a particular HARQ, component carrier (CC), or slot level. Here, the modem may provide a notification to set the ECN bits of a packet to the application processor, the interconnect, or the PDCP layer, and the notification may include an indication of a particular HARQ. In a second example, the ECN bit of a packet may be set if the packet is received after N number of RLC retransmissions, which may indicate that the delay is attributed to at least one of a reassembly timer, a status prohibit, and/or a retransmission latency. In some examples, a reassembly timer (tReassembly) is a component of the packet reassembly process, used in networking protocols like TCP/IP. When data is transmitted via a network, it may be broken down into smaller segments or packets. Each packet is then transmitted separately, and they may take different paths to the destination. Once the packets arrive at the destination (e.g., the UE), they need to be reassembled back into the original piece of data. The reassembly timer is started when the first packet of a set arrives. If the full set of packets isn't received before the reassembly timer expires, the partial data is discarded, and the UE may transmit a request for retransmission.

In wireless communications, a Status Prohibit Timer may be related to a HARQ process used for error correction. When a packet of data is sent, the receiver sends an acknowledgment (ACK) or negative acknowledgment (NACK) back to the sender. When the sender receives a NACK, it knows that the packet must be retransmitted. However, to prevent the receiver from being overwhelmed with status reports (ACKs or NACKs), the status prohibit timer is set. While this timer is running, the receiver will not send any more status reports to the sender, no matter how many more packets are received. Once the timer expires, the receiver can send another status report.

In some examples, the retransmission latency refers to a time delay from when a packet of data is originally sent until it is successfully retransmitted after an unsuccessful or faulty transmission. This can be due to various factors such as packet loss, interference, congestion, or weak signal strength.

In certain aspects, whether an ECN bit is set may be based on whether a dual connectivity mode is operational. Dual connectivity may result in increased delays in a link due to link specific scheduling or radio conditions. Such radio conditions may include “NumRx,” which may refer to a number of receive antennas in a MIMO system. The term “NumRx” denotes the number of antennas at the receiver end used to receive the data signals. Other radio conditions may include carrier aggregation and bandwidth part (BWP) configurations.

In one example using dual connectivity, the UE may communicate with a network entity via two links: a first link being a 20 megahertz LTE band and a second link being a 200 megahertz NR band. Thus, the amount of data which the UE receives on one link may be relatively smaller compared to the other link. In other words, a relatively large among of data may be received on one link, and that data is being buffered because the sequence number on the slower link is being received slower. This dissimilarity in data rate may be due to NumRx, carrier aggregation and/or BWP configurations.

In certain aspects, whether an ECN bit is set may be based on configuration aspects that result in packet delay and latency, for example different secondary cell group and master cell group configurations. In one example, a dual connectivity configuration may configure the UE to use an LTE link and an NR link, or an FR1 link and an FR2 link, or the like. Other configuration parameters may include different types or configurations of status and polling triggers. For example, on one link, the UE may be configured to request for status every 20 millisecond, but on the other link, the UE is configured to request for status every 200 ms. Thus, in this example, even though the transmission happens immediately, the UE does not request status until 200 milliseconds later, which introduces delay when a lost packet is not reported for retransmission for that long of a status delay.

In some examples, whether an ECN bit is set may be based on BWP information and/or a number of HARQs allocated resulting in increased delay. For example, one link may be a 20 megahertz link, and the other link may be a 100 megahertz link. Such a disparity in link bandwidth may result in delays. In another example, the UE may transmit two HARQs on one link, but also transmit 8 HARQs on the other link. This may also result in latency for packet recovery.

In certain aspects, whether an ECN bit is set may be based on whether PDCP out of order delivery is used for packets with an IP header indicating L4S service requested, and PDCP in-order deliver for other packets. L4S needs low latency and should not be delayed by PDCP out of order delivery. For example, if packets of one flow can be delivered out of order, but packets of another flow are required to be delivered in order. Such a situation may result in additional latencies.

The above examples describe instances where certain configurations and/or communications may result in packet delays and latencies at the UE. The following are examples aspects defining actions the UE may take to mitigate such delays.

In certain aspects, the UE may be configured to override a PDCP reordering timer for L4S specific flows. In some examples, a single PDCP reordering timer may be used for all flows associated with a particular bearer. Thus, the UE may override such a single PDCP reordering timer (e.g., default timer) for particular types of traffic, such as L4S traffic, but not for non-L4S traffic. Here, the UE may use a different timer value for L4S traffic. For example, if the default PDCP reordering timer is 300 ms, but the UE is aware of L4S traffic, then the UE may use a 250 ms timer for the L4S traffic to enable relatively faster delivery of L4S packets. In some examples, the UE may be configured to override the default timer: for specific L4S flows (e.g., as indicated by the network or UE), based on the buffering aspects, based on importance of the traffic, or for all non-L4S traffic associated with a particular buffer.

In certain aspects, a UE may set ECN bits of a packet based on PDU Set configurations (e.g., associated with XR). In one example, UE radio protocol may set ECN bits of specific packets when PSI based PDU discard is exercised with NW based congestion handling. For example, the UE may determine that congestion is occurring if PSI-based discard results in P-frames being dropped but not I-frames. Thus, if the UE is receiving only I-frames but no P-frames, the UE may determine there is congestion and may mark the ECN associated with the received packets. For example, if the UE receives two I-frames in a row, then the UE may determine that the network is in congestion.

In another example, the UE PDCP layer may mark specific packets with ECN when those packets are lost in the PDU Set though PSIHI (or other integrity handling parameter) indicated all packets are not necessary, while delivering the packets to Data plane from PDCP Reordering queue. The PSIHI may indicate whether all the packets are needed or not in the PDU Set for successful decoding based on level of FEC techniques (redundant packets along with systematic packets). For example, the PSIHI may indicate that a certain number of packets less than all packets is OK for receiving at the UE. For instance, PSIHI may indicate that, out of the 200 packets, if the network can only send 180 packets, then the UE will receive the 180 packets. But if less than 180, then the UE will drop all the packets. Thus, if the UE receives fewer packets than allowed by the integrity handling parameter, then the UE may drop all those packets. If that happens, then the UE may mark the ECN bits of packets it receives following the packets it dropped to indicate that a previously received plurality of packets were dropped. Alternatively, if the UE receives fewer than all packets but is not required to drop those packets, the UE may mark the ECN bits of those packets to indicate that it did not receive all the packets.

In another example, in multi-modal association between flows (e.g., Video, Audio, Haptic) which provides combined immersive experience to application user, when one flow gets delayed, other associated flows may be marked with ECN in the PDCP layer itself before delivering the packets out of the PDCP reordering queue. Here, the different flows may need to be received together because if one flow is delayed, then the other flows may be buffered, thereby causing delays across all flows. Thus, the UE may mark the ECN bits of the other flows that are buffered and being delayed by another flow. In some examples, the UE may use QFI to determine which packets are delayed.

In another example, while delivering PDCP SN packets, the PDCP may mark their respective ECN bits when previous packets are discarded. For example, the UE expects packets 0-3, but only packets 1-3 are received and part of the reorder queue. Thus, packets 1-3 are delayed in the PDCP due to packet 0 not being received. Eventually, due to expiration of the reordering timer, the UE may deliver packets 1-3 to the application processor. Here, the UE may mark the ECN bits of packets 1-3 prior to passing the packets to the application processor to indicate that packet 0 has been dropped. Alternatively, the network may explicitly inform the UE that it has discarded packet 0 (e.g., via a PDCP Control PDU to move the window quickly (XR new agreement) at UE). Here, the UE may also mark the ECN bits of packets 1-3 prior to delivering the packets to the application processor.

### Examples of UE-Side Uplink Modem Aspects

Aspects are directed to radio protocol qualities of the end to end L4S concepts so that the L4S is capable of working in an improved manner in a radio environment. This may include determining, by the network entity and/or UE, when congestion happens and indicating the congestion in an IP header. This part is typically done by the routers in the IP protocol level, which is the expectation of the RFC. However, once a device gets into a PDCP packet, the IP domain qualities may be lost. Thus, even when the data is in the radio protocol, the congestion situation can be identified and the ECN header marked. In certain aspects, a level where a condition is determined may indicate a level of fairness that may be applied at the UE. Thus, there is a need to determine at what level a condition exists or the level from which the condition can be detected so that an ECN can be marked at that level.

The UE may determine when congestion happens and indicate the congestion in an ECN field of an IP header of a packet. It should be noted that the ECN bit may be set at any of the IP level, SDAP level, PDCP level, RLC level, and MAC level. For example, if a PDCP packet is delayed, then the UE or UE's modem may set the bit at the PDCP level. Since the bit is set at the PDCP level, the packet may be cyphered again. The UE/Modem may act as a concentration point, gathering flows from various hosts/clients, and servicing them using various Subscriptions, PDU sessions, Bearers, priority queues. The level where congestion is determined determines at what level fairness is applied, and the UE/modem has several options: (1) at the UE-level: sum of all the bearers or all subs. Here, the UE may detect congestion or queueing delay based on monitoring all radio bearers and/or subscriptions operating on the UE; (2) at the “host/client” level. Here, the UE may monitor individual data flows, bearers, and/or subscriptions based on, for example, the monitored flow(s) being a relatively high priority flow; (3) at the Subscription level: sum of all the bearers for this Subscription. In a multi-SIM example, the UE may monitor traffic flows, radio bearers, subscriptions associated with one or more SIMs; (4) at the PDN level: the UE may monitor one or more bearers associated with a PDN; (5) at the bearer level: the UE may monitor one or more the flows of a particular one or more radio bearers; (6) at the priority-queue level of a bearer: the UE may monitor one or more bearers based on priority or other communication metric; and/or (7) latency may be detected by a UE by monitoring which flows get ECN congestion marked when an UL communication experiences congestion.

Thus, in certain aspects, if the UE detects congestion, the UE may mark packets that are part of flows of that UE. However, in some examples, the UE may marks based on different rules or parameters. As discussed above at (1-7), ECN marking may occur at various levels within the UE.

For example, (1) may relate to all the uplink traffic that flows through the UE. In some examples, a UE and/or its modem may have multiple clients to which it is connected. For example, clients may include HLOS (e.g., android), WiFi clients, tethered clients, clients established via ethernet. Here, a traffic flow with the HLOS client may be relatively slow, meaning that an associated buffer is not filling up. Thus, the UE may not mark ECN packets associated with the HLOS client. But traffic from a WiFi hotspot may be relatively fast, and filling up associated buffers. Thus, at the Wi-Fi hotspot level, the UE may mark the ECN field of packets for the WiFi hotspot client. In other words, the UE may mark packets at different levels or layers, depending on implementation of (1-7) above.

Another option discussed is the PDN level. Different PDNs may include a PDN for Internet access, another PDN for service like IMS, voice, text, etc. The UE may set ECN bits at the PDN level, wherein any threshold condition for marking the ECN bits may be the same across all PDNs, or specific to a particular PDN or group of PDNs. Because different PDNs may be associated with different rules, services, etc., the UE may set ECN bits of packets associated with different PDNs based on different threshold conditions associated with each PDN. Similarly, the UE may set ECN bits at the bearer level, wherein any threshold condition for marking the ECN bits may be the same across all bearers, or specific to a particular bearer or group of bearers. In one example, there may be no congestion at a first queue associated with a first bearer, whereas there is congestion at a second queue associated with a second bearer. Thus, the UE may set ECN bits of packets of the second bearer but not the first bearer.

In another example, an internet bearer may be associated with multiple queues each having a different priority. Thus, setting the ECN bit of a packet may be based on which queue the packets is associated. In other words, the marking of the ECN packet may be different depending on the queue and priority associated with the queue.

In certain aspects, the UE may detect congestion, and in response to the congestion, the UE may set the ECN of a congested packet before the packet is passed to the PDCP layer. In other words, the data domain may be configured to detect a radio congestion situation.

In certain aspects, the UE may detect congestion if the content of an UL queue (e.g., PDCP UL Queue or Total data yet to be transmitted for the first time or total data yet to be successfully acknowledged by receiver) built up in a modem of the UE satisfies a threshold condition. For example, 100 kilobytes of data may already be buffered in the PDCP. Here, a threshold condition is met when the buffered data at the PDCP is equal to or greater than 100 KB. Thus, while the threshold condition is met, any data that the UE is going to enqueue into the PDCP, the UE may mark with L4S ECN.

The process of indicating congestion applies when UE determines congestion (e.g., queueing delay, lost packet, or other communication parameter meets a threshold condition) and marks a ECN congestion bit. In some cases, the UE may detect congestion at the time of a first radio transmission (e.g., for the PDCP SDU or RLC SDU). If later a retransmission is needed and the congestion has reduced or disappeared, the UE may un-mark the congestion that it had marked during the first transmission, by toggling the ECN congestion bit to the original setting.

In one example, the UE may have detected congestion associated with a particular data flow when the UE transmits a packet for the first time on that data flow. Accordingly, the UE may set an ECN bit in the IP header of that packet. However, if an uplink retransmission is later required for that packet, but the congestion of the corresponding data flow has dropped below a threshold (e.g., the UE no longer considers the flow “congested”), then the UE may unmark the ECN that it had marked during the original transmission of that packet. In other words, the UE may mark/unmark the ECN bit at any point in time.

In some examples, the UE may detect delays based on a HARQ BLER or an RLC ARQ associated with a packet delay. Here, a HARQ BLER or an RLC ARQ may result in retransmissions which may increase latency to a degree where the UE is triggered to set the ECM bit (e.g., if a latency associated with a HARQ BLER satisfies a threshold condition, the ECN bit is set). The UE may: (1) mark the packets which are in PDCP UL Queue (PDCP SDU=IP Packet), for a PDCP first transmission, or a PDCP retransmission that can happen after a handover with status report indicating NACK; (2) mark the packets which are in RLC Tx Queue through reprocessing the PDCP Ciphering and Integrity aspects; and/or (3) mark the packets which are in RLC ReTx Queue. After modifying the ECN bit(s) the PDCP may reprocess the PDCP Ciphering and Integrity aspects.

The UE may also detect delays based on Dual Connectivity mode may also result in increased delays in specific link(s) due to link specific scheduling or radio conditions (e.g., CSI/Pathloss). Here, the UE may detect the delay and: (1) mark the packets which are in RLC Tx Queue through reprocessing the PDCP Ciphering and Integrity aspects; and/or (2) mark the packets which are in RLC ReTx Queue through reprocessing the PDCP Ciphering and Integrity aspects.

The UE may also detect delays based on configuration aspects that may result in additional delays, such as: (1) ul-DataSplitThreshold resulting in delayed delivery of packets on specific link which is faster than current transmission link (FR1 vs FR2 or LTE vs NR); (2) status and Polling triggers associated which are resulting in delayed retransmission opportunities to ensure quick in-seq delivery; (3) based on BWP information or Number of HARQs allocated which is resulting in increased delay.

When the UE detects congestion (e.g., resulting from the above-mentioned aspects, the UE may set the ECN bit associated with a packet. In some examples, the UE may perform additional steps to reduce the detected congestion: (1) override the ul-DataSplitThreshold for L4S traffic and send the L4S traffic on the faster link or submit to any link as if a threshold condition is met; (2) override the PDCP Discard timer differently for L4S specific flows based on the buffering aspects, importance of the traffic (ECN marked packets) or for non-L4S traffic outstanding with regard to total outstanding buffer; (3) override the MAC LCP policies in terms of BSD/PBR to prioritize the L4S traffic transmission to address the ECN packets are transmitted quickly or total L4S traffic is prioritized; (4) in the PDU Set based configurations (e.g., XR), based on PDU Set marking across packets and defined/configured PDU Set Metrics (PSDB, PSER, PSI, PSIHI): (i) the UE can mark specific packets with ECN, when specific packets are lost in the PDU Set though PSIHI indicated all packets are not necessary. PSIHI may indicate whether all the packets are needed or not in the PDU Set for successful decoding based on level of FEC techniques (redundant packets along with systematic packets); (ii) mark the following PDCP SN packets, when previous packets are discarded and informed to NW through PDCP Control PDU to move the window quickly (e.g., based on XR agreement).

### Examples of Network Entity-Side (RAN Level) Aspects

In certain aspects, a network entity may detect downlink delays and perform operations configured to reduce such delays. Such operations may include setting ECN bits of packets associated with a packet delay. For example, the network entity may mark the ECN bits of packets which are received by the PDCP/CU and waiting in a transmitting queue beyond a threshold time, waiting to transmit to RLC/DU. Thus, if a packet remains in a queue for a duration of time that is greater than a threshold duration, then the network entity may set the ECN bits of that packet to indicate the delay. Such delays may be due to flow control aspects of the NR-U link between the DU and CU that limit the amount of data that a network entity may receive and/or hold in queue. Such delays may also be due to variation in the capacity of the link across multiple links in dual connectivity. For example, different scheduling among the links may cause packets to remain in queue for relatively long durations of time.

In another example, the network entity may mark the ECN of packets received in the network entity if there are identified packet loss-recovery over NR-U GTP-U based link. For example, when a packet is lost at the NR-U link, the network entity may perform multiple retransmissions to recover the packet. While the retransmissions are occurring, other packets may be delayed at buffers at the CU and/or DU. Thus, the network entity may mark the ECN field of a packet and/or associated packets if that packet(s) is delayed due to multiple retransmissions. In some examples, the network entity may mark the ECN bits if the number of retransmissions is equal to or greater than a threshold value (e.g., integer value). It should be noted that there may be feedback-based retransmissions and flow control support. Even when no outstanding packets, this additional delay for the current packet which is expected PDCP SN can result in increased latency.

In another example, in some architectures, the network entity may not be configured to mark ECN bits to indicate congestion after a PDCP PDU is processed (ciphered, MAC-I computed), yet the radio system may experience congestion that should be signaled to the end point (e.g., application server). In this case, the network entity may provide congestion information to the UE or another network entity via a PDCP (or other radio protocol) bit in the data header, or a control PDU. Thus, when the PDCP receiver handles the reception of the PDCP PDU, it may check the ECN congestion in the PDCP meta-data and if marked, the PDCP layer may add it to the IP ECN header after the deciphering.

Although a network entity may receive data from a UE in an UL direction, the network entity may also include layers that may contribute to latency. For example, data may be retransmitted between the UE and network via the MAC layer causing delay, the RLC layer at the network entity may perform management and recovery of lost packets through a status mechanism, and the PDCP layer at a CU may be required to perform data aggregation and reordering management between one or more DUs based on whether dual/single connectivity is used.

In certain aspects, the network entity may detect delays and perform operations configured to reduce such delays. For example, the network entity may: (1) mark the packets which are already received in the PDCP and waiting in reordering queue (with in-sequence delivery configuration), waiting for earlier PDCP PDUs to meet the in-sequence delivery. All the packets may experience the worst-case delay, due to: (i) last packet which reached to unblock in-sequence delivery; (ii) Timer Reordering expiry at receiving PDCP module; and/or (iii) due to transmitter sending the PDCP Control PDU with the info of dropped packets.

In one example, a UE may transmit an uplink package containing packets 0, 1, 2, and 3. However, the network entity may only receive uplink packets 1, 2, and 3. Thus, packets 1, 2, and 3 may remain in a queue while the network entity waits for a retransmission of packet 0. In this example, if packets 1, 2, and 3 remain in the queue for a threshold period of time, the network entity may mark an ECN associated with one or more of packets 1, 2, and 3 before transmitting the packets to the application server.

For example, the network entity may receive packet 0 after one or more retransmissions which results in 100 milliseconds of delay. Due to retransmission of the packet, the UE zero may mark the ECN bit in the IP header of packet 0. However, from the gNB we perspective, even though packets 1, 2, and 3 have been received prior to packet 0 being received, packets 1, 2, and 3 remained in queue until the retransmission of packet 0 was received. Thus, when the network entity eventually delivers all of packets 0, 1, 2, and 3 to the application server, all four packets were delayed by 100 milliseconds. In other words, the network entity may mark the ECNs associated with packets 1, 2, and 3 due to their being delayed in a reordering queue while the network entity waits for packet 0 to be retransmitted.

Continuing from the above example, and from the application server perspective, all of packets 0-3 are delayed even though the network entity received packets 1-3 on time. So all the packets will experience the worst case delay due to: (a) the last packet which reached to unblock the in sequence delivery (e.g., if packet 0 is the one which got delayed 100 milliseconds, that means even 123 are also delayed by 100 milliseconds); (b) timer reordering expiring: e.g., packet 0 was never received and timer reordering is expired, so packets 1-3 are delivered even though 123 came 100 milliseconds behind, they are delivered 100 milliseconds later because the timer is 100 millisecond timer; or (c) transmitter (e.g., UE) transmits a control PDU to the network entity that instructs the network entity to deliver packets 1-3 to the application server and notifies the network entity that it should not expect to receive packet 0.

Thus, according to some examples, the network entity may mark corresponding ECNs of properly received packets if transmission of those packets to the application server are delayed for one or more of the reasons discussed above.

In some examples, the network entity may mark the packets received in the CU, due to Intra/Inter-gNB DU Link associated delays to CU-UP located in one place. For example, one or more packets may be delayed at a link (e.g., NR-U, illustrated above) between a DU and a CU due to, for example, a UDP IP based GTP-U tunneling protocol, a scheduling issue, and/or packet loss and retransmission between the CU and DU. For example, when packets are discarded or lost, the PDCP uplink may request the DU RLC to reTx (e.g., via the status mechanism) the lost packets. Thus, the NR-U link may cause an additional delay. Such delays may result in packets being further delayed towards the core network and application server. Thus, the CU or the DU may mark an ECN bit associated with packets delayed due to intra- or inter-DU to CU-CP link delays.

Thus, additional delays at the network entity side may be detected and may result in the network entity marking an ECN bit associated with a delayed packet. Accordingly, when the application server receives the delayed packet, it knows that ECN bit is appropriately set in the radio environment.

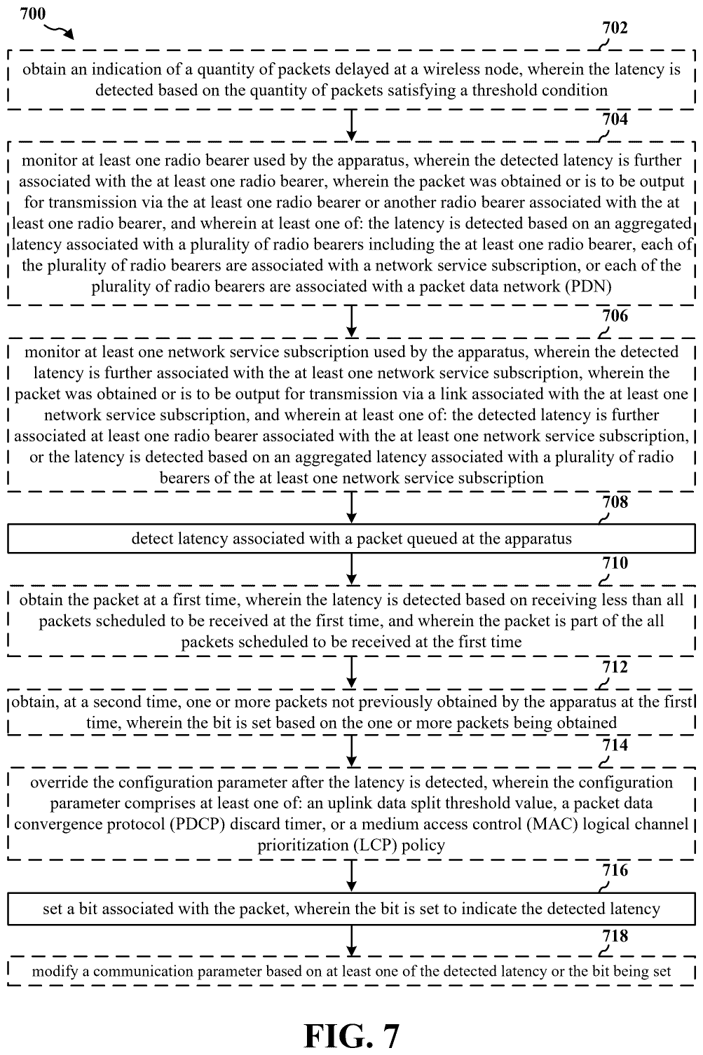

FIG. 7 is a flowchart 700 of a method of wireless communication. The method may be performed by a UE (e.g., the UE 104; the apparatus 1002). Specifically, the method may be performed by one or more memories, processors, and RF front ends (e.g., the memory 360, controller/processor 359, transmitter 354TX, receiver 354RX, antenna 352, etc. of FIG. 3). The method may also be performed by a network entity or base station (e.g., the base station 102/180; the apparatus 1102. Specifically, the method may be performed by one or more memories, processors, and RF front ends (e.g., the memory 376, controller/processor 375, transmitter 318TX, receiver 318RX, antenna 320, etc. of FIG. 3).

At 702, the UE and/or network entity may obtain an indication of a quantity of packets delayed at a wireless node, wherein the latency is detected based on the quantity of packets satisfying a threshold condition. For example, 702 may be performed by an obtaining component 1046/1146.

At 704, the UE and/or network entity may monitor at least one radio bearer used by the apparatus, wherein the detected latency is further associated with the at least one radio bearer, wherein the packet was obtained or is to be output for transmission via the at least one radio bearer or another radio bearer associated with the at least one radio bearer, and wherein at least one of: the latency is detected based on an aggregated latency associated with a plurality of radio bearers including the at least one radio bearer, each of the plurality of radio bearers are associated with a network service subscription, or each of the plurality of radio bearers are associated with a packet data network (PDN). For example, 704 may be performed by a monitoring component 1048/1148.

At 706, the UE and/or network entity may monitor at least one network service subscription used by the apparatus, wherein the detected latency is further associated with the at least one network service subscription, wherein the packet was obtained or is to be output for transmission via a link associated with the at least one network service subscription, and wherein at least one of: the detected latency is further associated at least one radio bearer associated with the at least one network service subscription, or the latency is detected based on an aggregated latency associated with a plurality of radio bearers of the at least one network service subscription. For example, 706 may be performed by the monitoring component 1048/1148.

At 708, the UE and/or network entity may detect latency associated with a packet queued at the apparatus. For example, 708 may be performed by a detecting component 1040/1140.

At 710, the UE and/or network entity may obtain the packet at a first time, wherein the latency is detected based on receiving less than all packets scheduled to be received at the first time, and wherein the packet is part of the all packets scheduled to be received at the first time. For example, 710 may be performed by the obtaining component 1046/1146.

At 712, the UE and/or network entity may obtain, at a second time, one or more packets not previously obtained by the apparatus at the first time, wherein the bit is set based on the one or more packets being obtained. For example, 712 may be performed by the obtaining component 1046/1146.

At 714, the UE and/or network entity may override the configuration parameter after the latency is detected, wherein the configuration parameter comprises at least one of: an uplink data split threshold value, a packet data convergence protocol (PDCP) discard timer, or a medium access control (MAC) logical channel prioritization (LCP) policy. For example, 714 may be performed by an overriding component 1050/1150.

At 716, the UE and/or network entity may set a bit associated with the packet, wherein the bit is set to indicate the detected latency. For example, 716 may be performed by a setting component 1042/1142.

At 718, the UE and/or network entity may optionally modify a communication parameter based on at least one of the detected latency or the bit being set. For example, 718 may be performed by a modifying component 1044/1144.

In certain aspects, the bit is associated with an explicit congestion notification (ECN) field of the packet.

In certain aspects, the bit is set at one or more of: an application processor, an interconnect coupled to a modem and the application processor, and a packet data convergence protocol (PDCP) layer.

In certain aspects, the bit is set at one or more of an internet protocol (IP) layer, a service data adaptation protocol (SDAP) layer, a packet data convergence protocol (PDCP) layer, a radio link control (RLC) layer, and a medium access control (MAC) layer.

In certain aspects, the latency is detected based on at least one of: a duration of time during which the packet spends in a queue satisfying a threshold condition, an indication that the packet was dropped in association with a PDU set integrity handling indication, a quantity of retransmissions of the packet satisfying a threshold condition, the packet being held in a retransmission queue, or a negative acknowledgment (NACK) associated with the packet.

In certain aspects, the latency is detected based on one or more radio parameters of at least one link in a dual connectivity communication operation associated with the apparatus, wherein the packet was obtained or to be output for transmission via the at least one link.

In certain aspects, at least one of: the one or more radio parameters comprise at least one of: (i) a bandwidth difference between a first link and a second link, (ii) a carrier aggregation configuration, (iii) a quantity of receive antennas used for dual connectivity communication, or (iv) a bandwidth part configuration, or the latency is detected further based on at least one of a status trigger configuration or a polling trigger configuration of the at least one link of the dual connectivity communication.

In certain aspects, the packet is associated with a first data flow of a plurality of multi-modal data flows, wherein another packet is associated with a second data flow of the plurality of multi-modal data flows, and wherein the latency is detected based on a delay of the other packet.

In certain aspects, the latency is further based on the packet being stored in a reordering queue for a duration of time greater than or equal to a threshold value.

In certain aspects, the bit is set based an expiration of a reordering timer associated with the less than all packets scheduled to be received at the first time, wherein the timer operates at a packet data convergence protocol (PDCP) layer of the apparatus.

In certain aspects, the latency is detected based on packet loss over an NR-U link, wherein the packet was obtained or is to be output for transmission via the NR-U link.

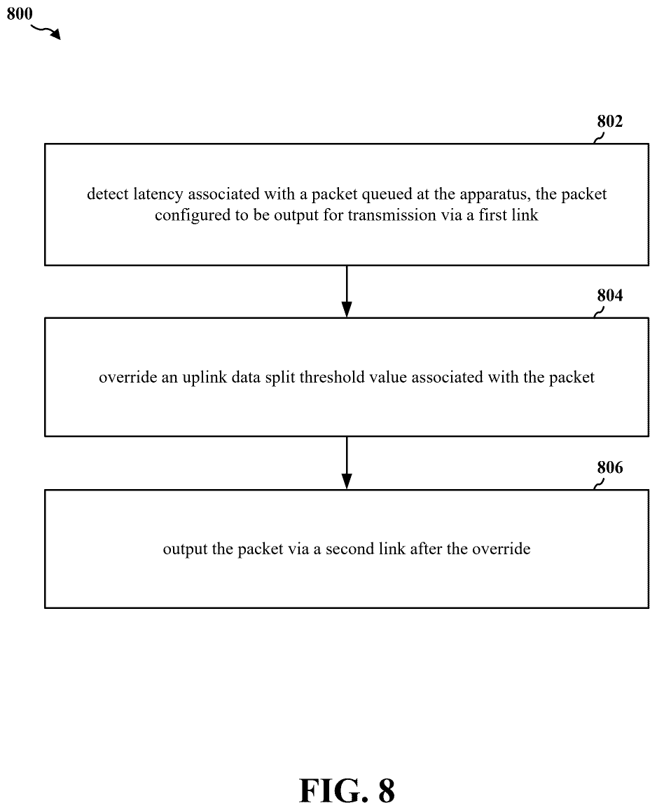

FIG. 8 is a flowchart 800 of a method of wireless communication. The method may be performed by a UE (e.g., the UE 104; the apparatus 1002). Specifically, the method may be performed by one or more memories, processors, and RF front ends (e.g., the memory 360, controller/processor 359, transmitter 354TX, receiver 354RX, antenna 352, etc. of FIG. 3). The method may also be performed by a network entity or base station (e.g., the base station 102/180; the apparatus 1102. Specifically, the method may be performed by one or more memories, processors, and RF front ends (e.g., the memory 376, controller/processor 375, transmitter 318TX, receiver 318RX, antenna 320, etc. of FIG. 3).

At 802, the UE and/or network entity may detect latency associated with a packet queued at the apparatus, the packet configured to be output for transmission via a first link. For example, 802 may be performed by a detecting component 1040/1140.

At 804, the UE and/or network entity may override an uplink data split threshold value associated with the packet. For example, 804 may be performed by an overriding component 1050/1150.

At 806, the UE and/or network entity may output the packet via a second link after the override. For example, 806 may be performed by an outputting component 1052/1152.

In certain aspects, the packet is configured to be communicated via a low latency, low loss, and scalable throughput (L4S) communication protocol, and wherein the override is based on at least one of the detected latency and the packet being communicated via L4S.

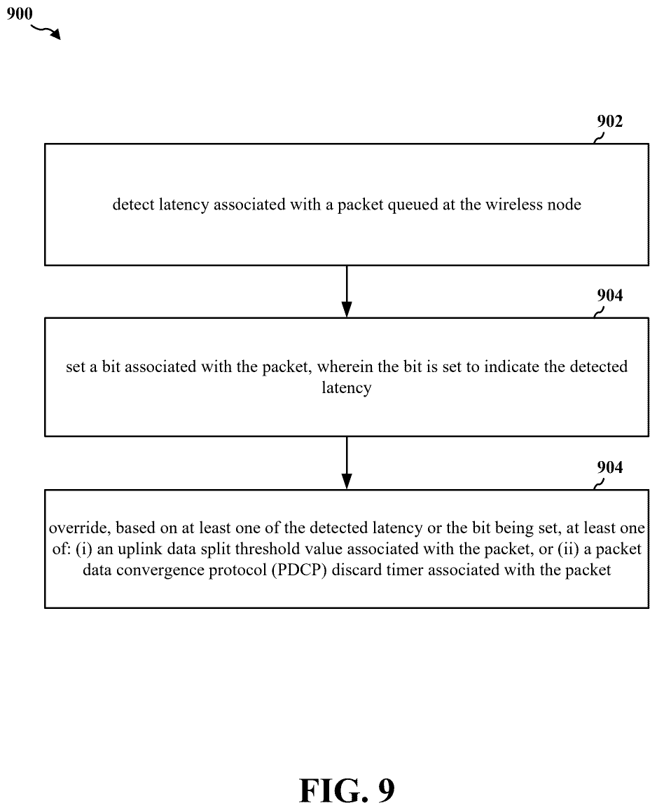

FIG. 9 is a flowchart 900 of a method of wireless communication. The method may be performed by a UE (e.g., the UE 104; the apparatus 1002). Specifically, the method may be performed by one or more memories, processors, and RF front ends (e.g., the memory 360, controller/processor 359, transmitter 354TX, receiver 354RX, antenna 352, etc. of FIG. 3). The method may also be performed by a network entity or base station (e.g., the base station 102/180; the apparatus 1102. Specifically, the method may be performed by one or more memories, processors, and RF front ends (e.g., the memory 376, controller/processor 375, transmitter 318TX, receiver 318RX, antenna 320, etc. of FIG. 3).

At 902, the UE and/or network entity may detect latency associated with a packet queued at the apparatus, the packet configured to be output for transmission via a first link. For example, 902 may be performed by a detecting component 1040/1140.

At 904, the UE and/or network entity may override an uplink data split threshold value associated with the packet. For example, 904 may be performed by an overriding component 1050/1150.

At 906, the UE and/or network entity may output the packet via a second link after the override. For example, 906 may be performed by an outputting component 1052/1152.

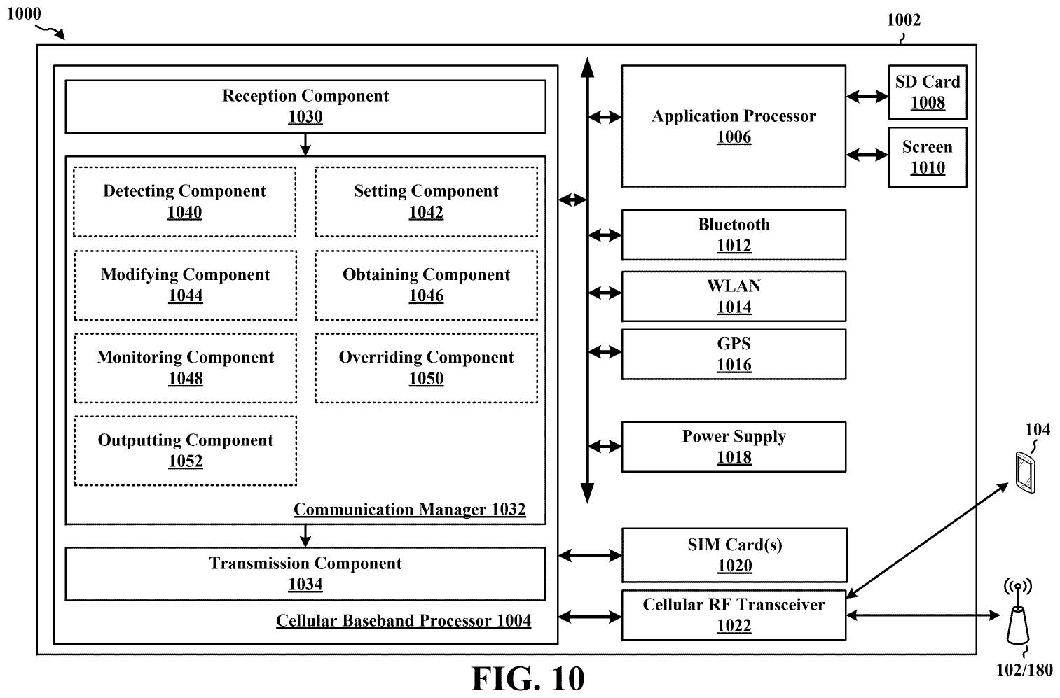

FIG. 10 is a diagram 1000 illustrating an example of a hardware implementation for an apparatus 1002. The apparatus 1002 is a UE and includes a cellular baseband processor 1004 (also referred to as a modem) coupled to one or more cellular RF transceivers 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018. The cellular baseband processor 1004 communicates through the one or more cellular RF transceivers 1022 with the UE 104 and/or BS 102/180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 1004 when executing software. The cellular baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the cellular baseband processor 1004. The cellular baseband processor 1004 may be a component of the UE 104 and may include the memory 360 and/or at least one of the TX processor 368, the RX processor 356, and the controller/processor 359. In one configuration, the apparatus 1002 may be a modem chip and include just the baseband processor 1004, and in another configuration, the apparatus 1002 may be the entire UE (e.g., see UE 104 of FIG. 3) and include the aforediscussed additional modules of the apparatus 1002. In various examples, the apparatus 1002 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1032 includes a detecting component 1040 that is configured to: detect latency associated with a packet queued at the apparatus; and detect latency associated with a packet queued at the apparatus, the packet configured to be output for transmission via a first link; e.g., as described in connection with 708, 802, and 902.

The communication manager 1032 further includes a setting component 1042 configured to set a bit associated with the packet, wherein the bit is set to indicate the detected latency, e.g., as described in connection with 716 and 904.

The communication manager 1032 further includes a modifying component 1044 configured to modify a communication parameter based on at least one of the detected latency or the bit being set, e.g., as described in connection with 718.

The communication manager 1032 includes an obtaining component 1046 that is configured to: obtain an indication of a quantity of packets delayed at a wireless node, wherein the latency is detected based on the quantity of packets satisfying a threshold condition; obtain the packet at a first time, wherein the latency is detected based on receiving less than all packets scheduled to be received at the first time, and wherein the packet is part of the all packets scheduled to be received at the first time; and obtain, at a second time, one or more packets not previously obtained by the apparatus at the first time, wherein the bit is set based on the one or more packets being obtained; e.g., as described in connection with 702, 710, and 712.

The communication manager 1032 includes a monitoring component 1048 that is configured to: monitor at least one radio bearer used by the apparatus, wherein the detected latency is further associated with the at least one radio bearer, wherein the packet was obtained or is to be output for transmission via the at least one radio bearer or another radio bearer associated with the at least one radio bearer, and wherein at least one of: the latency is detected based on an aggregated latency associated with a plurality of radio bearers including the at least one radio bearer, each of the plurality of radio bearers are associated with a network service subscription, or each of the plurality of radio bearers are associated with a packet data network (PDN); and monitor at least one network service subscription used by the apparatus, wherein the detected latency is further associated with the at least one network service subscription, wherein the packet was obtained or is to be output for transmission via a link associated with the at least one network service subscription, and wherein at least one of: the detected latency is further associated at least one radio bearer associated with the at least one network service subscription, or the latency is detected based on an aggregated latency associated with a plurality of radio bearers of the at least one network service subscription; e.g., as described in connection with 704 and 706.

The communication manager 1032 includes an overriding component 1050 that is configured to: override the configuration parameter after the latency is detected, wherein the configuration parameter comprises at least one of: an uplink data split threshold value, a packet data convergence protocol (PDCP) discard timer, or a medium access control (MAC) logical channel prioritization (LCP) policy; override an uplink data split threshold value associated with the packet; and override, based on at least one of the detected latency or the bit being set, at least one of: (i) an uplink data split threshold value associated with the packet, or (ii) a packet data convergence protocol (PDCP) discard timer associated with the packet; e.g., as described in connection with 714, 804, and 904.

The communication manager 1032 includes an outputting component 1052 that is configured to: output the packet via a second link after the override; e.g., as described in connection with 806.

The apparatus may include additional components that perform each of the blocks of the algorithm in the aforementioned flowchart of FIG. 7. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the cellular baseband processor 1004, includes: means for detecting latency associated with a packet queued at the apparatus; means for setting a bit associated with the packet, wherein the bit is set to indicate the detected latency; and means for modifying a communication parameter based on at least one of the detected latency or the bit being set; means for obtaining an indication of a quantity of packets delayed at a wireless node, wherein the latency is detected based on the quantity of packets satisfying a threshold condition; means for monitoring at least one radio bearer used by the apparatus, wherein the detected latency is further associated with the at least one radio bearer, wherein the packet was obtained or is to be output for transmission via the at least one radio bearer or another radio bearer associated with the at least one radio bearer, and wherein at least one of: the latency is detected based on an aggregated latency associated with a plurality of radio bearers including the at least one radio bearer, each of the plurality of radio bearers are associated with a network service subscription, or each of the plurality of radio bearers are associated with a packet data network (PDN); means for monitoring at least one network service subscription used by the apparatus, wherein the detected latency is further associated with the at least one network service subscription, wherein the packet was obtained or is to be output for transmission via a link associated with the at least one network service subscription, and wherein at least one of: the detected latency is further associated at least one radio bearer associated with the at least one network service subscription, or the latency is detected based on an aggregated latency associated with a plurality of radio bearers of the at least one network service subscription; means for detecting latency associated with a packet queued at the apparatus; means for obtaining the packet at a first time, wherein the latency is detected based on receiving less than all packets scheduled to be received at the first time, and wherein the packet is part of the all packets scheduled to be received at the first time; means for obtaining, at a second time, one or more packets not previously obtained by the apparatus at the first time, wherein the bit is set based on the one or more packets being obtained; means for overriding the configuration parameter after the latency is detected, wherein the configuration parameter comprises at least one of: an uplink data split threshold value, a packet data convergence protocol (PDCP) discard timer, or a medium access control (MAC) logical channel prioritization (LCP) policy; means for setting a bit associated with the packet, wherein the bit is set to indicate the detected latency; means for modifying a communication parameter based on at least one of the detected latency or the bit being set; means for detecting latency associated with a packet queued at the wireless node; means for setting a bit associated with the packet, wherein the bit is set to indicate the detected latency; and means for overriding, based on at least one of the detected latency or the bit being set, at least one of: (i) an uplink data split threshold value associated with the packet, or (ii) a packet data convergence protocol (PDCP) discard timer associated with the packet.

The aforementioned means may be one or more of the aforementioned components of the apparatus 1002 configured to perform the functions recited by the aforementioned means. As described supra, the apparatus 1002 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Means for receiving or means for obtaining may include a receiver (such as the receive processor 370) and/or an antenna(s) 320 of the network entity 102/180 or the receive processor 356 and/or antenna(s) 352 of the UE 104 illustrated in FIG. 3. Means for transmitting or means for outputting may include a transmitter (such as the transmit processor 316) or an antenna(s) 320 of the network entity 102/180 or the transmit processor 368 or antenna(s) 352 of the UE 104 illustrated in FIG. 3. Means for detecting, means for setting, means for overriding, means for monitoring, and means for modifying may include a processing system, which may include one or more processors, such as the controller/processor 359, the memory 360, and/or any other suitable hardware components of the UE 104 illustrated in FIG. 3, or the controller/processor 375, the memory 376, and/or any other suitable hardware components of the network entity 102 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

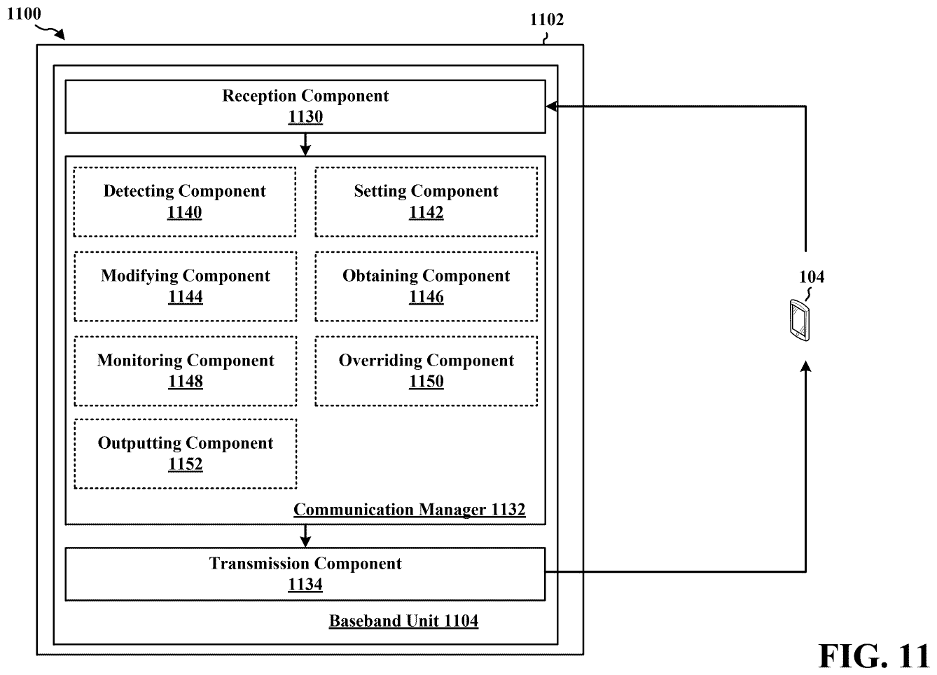

FIG. 11 is a diagram 1100 illustrating an example of a hardware implementation for an apparatus 1102. The apparatus 1102 is a BS and includes a baseband unit 1104. The baseband unit 1104 may communicate through one or more cellular RF transceivers with the UE 104. The baseband unit 1104 may include a computer-readable medium/memory. The baseband unit 1104 is responsible for general processing, including the execution of software stored on the computer-readable medium/memory. The software, when executed by the baseband unit 1104, causes the baseband unit 1104 to perform the various functions described supra. The computer-readable medium/memory may also be used for storing data that is manipulated by the baseband unit 1104 when executing software. The baseband unit 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the baseband unit 1104. The baseband unit 1104 may be a component of the BS 102/180 and may include the memory 376 and/or at least one of the TX processor 316, the RX processor 370, and the controller/processor 375. In various examples, the apparatus 1102 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1132 includes a detecting component 1140 configured to detect latency associated with a packet queued at the apparatus, e.g., as described in connection with 702. The communication manager 1132 further includes a setting component 1142 configured to set a bit associated with the packet, wherein the bit is set to indicate the detected latency, e.g., as described in connection with 704. The communication manager 1132 further includes a modifying component 1144 configured to modify a communication parameter based on at least one of the detected latency or the bit being set, e.g., as described in connection with 706.

The apparatus may include additional components that perform each of the blocks of the algorithm in the aforementioned flowchart of FIG. 7. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the cellular baseband processor 1104, includes: means for detecting latency associated with a packet queued at the apparatus; means for setting a bit associated with the packet, wherein the bit is set to indicate the detected latency; and means for modifying a communication parameter based on at least one of the detected latency or the bit being set; means for obtaining an indication of a quantity of packets delayed at a wireless node, wherein the latency is detected based on the quantity of packets satisfying a threshold condition; means for monitoring at least one radio bearer used by the apparatus, wherein the detected latency is further associated with the at least one radio bearer, wherein the packet was obtained or is to be output for transmission via the at least one radio bearer or another radio bearer associated with the at least one radio bearer, and wherein at least one of: the latency is detected based on an aggregated latency associated with a plurality of radio bearers including the at least one radio bearer, each of the plurality of radio bearers are associated with a network service subscription, or each of the plurality of radio bearers are associated with a packet data network (PDN); means for monitoring at least one network service subscription used by the apparatus, wherein the detected latency is further associated with the at least one network service subscription, wherein the packet was obtained or is to be output for transmission via a link associated with the at least one network service subscription, and wherein at least one of: the detected latency is further associated at least one radio bearer associated with the at least one network service subscription, or the latency is detected based on an aggregated latency associated with a plurality of radio bearers of the at least one network service subscription; means for detecting latency associated with a packet queued at the apparatus; means for obtaining the packet at a first time, wherein the latency is detected based on receiving less than all packets scheduled to be received at the first time, and wherein the packet is part of the all packets scheduled to be received at the first time; means for obtaining, at a second time, one or more packets not previously obtained by the apparatus at the first time, wherein the bit is set based on the one or more packets being obtained; means for overriding the configuration parameter after the latency is detected, wherein the configuration parameter comprises at least one of: an uplink data split threshold value, a packet data convergence protocol (PDCP) discard timer, or a medium access control (MAC) logical channel prioritization (LCP) policy; means for setting a bit associated with the packet, wherein the bit is set to indicate the detected latency; means for modifying a communication parameter based on at least one of the detected latency or the bit being set; means for detecting latency associated with a packet queued at the wireless node; means for setting a bit associated with the packet, wherein the bit is set to indicate the detected latency; and means for overriding, based on at least one of the detected latency or the bit being set, at least one of: (i) an uplink data split threshold value associated with the packet, or (ii) a packet data convergence protocol (PDCP) discard timer associated with the packet

The aforementioned means may be one or more of the aforementioned components of the apparatus 1102 configured to perform the functions recited by the aforementioned means. As described supra, the apparatus 1102 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Means for receiving or means for obtaining may include a receiver (such as the receive processor 370) and/or an antenna(s) 320 of the network entity 102/180 or the receive processor 356 and/or antenna(s) 352 of the UE 104 illustrated in FIG. 3. Means for transmitting or means for outputting may include a transmitter (such as the transmit processor 316) or an antenna(s) 320 of the network entity 102/180 or the transmit processor 368 or antenna(s) 352 of the UE 104 illustrated in FIG. 3. Means for detecting, means for setting, means for overriding, means for monitoring, and means for modifying may include a processing system, which may include one or more processors, such as the controller/processor 359, the memory 360, and/or any other suitable hardware components of the UE 104 illustrated in FIG. 3, or the controller/processor 375, the memory 376, and/or any other suitable hardware components of the network entity 102 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### Additional Considerations

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is a method at a wireless node, comprising: detecting latency associated with a packet queued at the wireless node; and setting a bit associated with the packet, wherein the bit is set to indicate the detected latency.

Example 2 is the method of Example 1, wherein the bit is associated with an explicit congestion notification (ECN) field of the packet.

Example 3 is the method of any of Examples 1 and 2, wherein the bit is set at one or more of an internet protocol (IP) layer, a service data adaptation protocol (SDAP) layer, a packet data convergence protocol (PDCP) layer, a radio link control (RLC) layer, and a medium access control (MAC) layer.

Example 4 is the method of any of Examples 1-3, wherein the latency is detected based on a duration of time, which the packet spends in a queue, satisfying a threshold condition.

Example 5 is the method of any of Examples 1-4, further comprising: obtaining an indication of a quantity of packets delayed at a wireless node, wherein the latency is detected based on the quantity of packets satisfying a threshold condition.

Example 6 is the method of any of Examples 1-5, wherein the latency is detected based on a quantity of retransmissions of the packet satisfying a threshold condition.

Example 7 is the method of any of Examples 1-6, wherein the latency is detected based on one or more radio parameters of at least one link in a dual connectivity communication operation associated with the wireless node, wherein the packet was obtained or to be output for transmission via the link or another link associated with the link.

Example 8 is the method of Example 7, wherein the one or more radio parameters comprise at least one of: (i) a bandwidth difference between a first link and a second link, (ii) a carrier aggregation configuration, (iii) a quantity of receive antennas used for dual connectivity communication, or (iv) a bandwidth part configuration.

Example 9 is the method of any of Examples 7 and 8, wherein the latency is detected further based on at least one of a status trigger configuration or a polling trigger configuration of the at least one link of the dual connectivity communication.

Example 10 is the method of any of Examples 1-9, wherein the latency is detected based on PDCP out-of-order delivery of non-low latency, low loss, and scalable throughput (non-L4S) packets communicated via a link, and wherein the packet was obtained or to be output for transmission via the link or another link associated with the link.

Example 11 is the method of any of Examples 1-10, wherein the packet is communicated via a low latency, low loss, and scalable throughput (L4S) communication protocol.

Example 12 is the method of any of Examples 1-11, further comprising: overriding a reordering timer associated with the packet after a delay detection.

Example 13 is the method of any of Examples 1-12, further comprising: obtaining contiguous I-frames, wherein the latency is detected based on the obtained I-frames being contiguous, and wherein a first I-frame of the obtained I-frames comprises the packet, or the packet was obtained or to be output for transmission via a same link from which the I-frame was obtained, or the packet was obtained or to be output for transmission via a same radio bearer from which the I-frame was obtained.

Example 14 is the method of any of Examples 1-13, wherein the packet is part of a packet data unit (PDU) set.

Example 15 is the method of Example 14, wherein the latency is detected based on an indication that the packet was dropped in association with a PDU set integrity handling indication.

Example 16 is the method of any of Examples 1-15, wherein the packet is associated with a first data flow of a plurality of multi-modal data flows, wherein another packet is associated with a second data flow of the plurality of multi-modal data flows, and wherein the latency is detected based on a delay of the other packet.

Example 17 is the method of Example 16, wherein the latency is further based on the packet being stored in a reordering queue for a duration of time greater than or equal to a threshold value.

Example 18 is the method of any of Examples 1-17, wherein the latency is detected based on packet loss over an NR-U link, wherein the packet was obtained or is to be output for transmission via the NR-U link.

Example 19 is the method of any of Examples 1-18, further comprising: communicating signaling comprising a packet data convergence protocol (PDCP) bit or a control packet data unit (PDU) configured to indicate the detected latency.

Example 20 is the method of any of Examples 1-19, further comprising: obtaining signaling comprising a packet data convergence protocol (PDCP) bit or a control packet data unit (PDU) configured to indicate the detected latency, wherein the latency is detected based on the obtained signaling, and wherein the obtained signaling indicates a link from which the packet was obtained or is to be output for transmission, another link associated with the link from which the packet was obtained or is to be output for transmission, a radio bearer comprising the link, or another radio bearer associated with the radio bearer comprising the link.

Example 21 is the method of any of Examples 1-20, further comprising: monitoring at least one radio bearer used by the wireless node, wherein the detected latency is further associated with the at least one radio bearer, and wherein the packet was obtained or is to be output for transmission via the at least one radio bearer or another radio bearer associated with the at least one radio bearer.

Example 22 is the method Example 21, wherein the latency is detected based on an aggregated latency associated with a plurality of radio bearers including the at least one radio bearer.

Example 23 is the method of Example 22, wherein each of the plurality of radio bearers are associated with a network service subscription.

Example 24 is the method of any of Examples 22 and 23, wherein each of the plurality of radio bearers are associated with a packet data network (PDN).

Example 25 is the method of any of Examples 21-24, further comprising: monitoring one or more queues associated with the at least one radio bearer, wherein the one or more queues are monitored based on whether a priority level associated with the queue satisfies a threshold condition.

Example 26 is the method of any of Examples 1-25, further comprising: monitoring at least one network service subscription used by the wireless node, wherein the detected latency is further associated with the at least one network service subscription, and wherein the packet was obtained or is to be output for transmission via a link associated with the at least one network service subscription.

Example 27 is the method of Example 26, wherein the detected latency is further associated at least one radio bearer associated with the at least one network service subscription.

Example 28 is the method of any of Examples 26 and 27, wherein the latency is detected based on an aggregated latency associated with a plurality of radio bearers of the at least one network service subscription.

Example 29 is the method of any of Examples 1-28, further comprising: monitoring one or more flows associated with an application server, wherein the detected latency is further associated with the one or more flows, and wherein the packet was obtained or is to be output for transmission via the at least one of the one or more flows.

Example 30 is the method of any of Examples 1-29, further comprising: outputting the packet for transmission after being queued; and obtaining a negative acknowledgment (NACK) associated with the packet, wherein the latency is detected further based on the obtained NACK.

Example 31 is the method of any of Examples 1-30, wherein the latency is detected based on the packet being held in a retransmission queue, and wherein the bit is set prior to retransmission.

Example 32 is the method of any of Examples 1-31, wherein the latency is detected based on a hybrid automatic repeat request (HARQ) block error rate (BLER) associated with the packet satisfying a threshold condition.

Example 33 is the method of any of Examples 1-32, wherein the latency is based on a configuration parameter, and wherein the method further comprises: overriding the configuration parameter after the latency is detected.

Example 34 is the method of Example 33, wherein the configuration parameter comprises at least one of: an uplink data split threshold value, a packet data convergence protocol (PDCP) discard timer, or a medium access control (MAC) logical channel prioritization (LCP) policy.

Example 35 is the method of any of Examples 1-34, wherein the packet is communicated via a low latency, low loss, and scalable throughput (L4S) communication protocol.

Example 36 is the method of any of Examples 1-35, further comprising: obtaining the packet at a first time, wherein the latency is detected based on receiving less than all packets scheduled to be received at the first time, and wherein the packet is part of the all packets scheduled to be received at the first time.

Example 37 is the method of Example 36, further comprising: obtaining, at a second time, one or more packets not previously obtained by the wireless node at the first time, wherein the bit is set based on the one or more packets being obtained.

Example 38 is the method of any of Examples 36 and 37, wherein the bit is set based an expiration of a reordering timer associated with the less than all packets scheduled to be received at the first time, wherein the timer operates at a packet data convergence protocol (PDCP) layer of the wireless node.

Example 39 is the method of any of Examples 36-38, further comprising: obtaining, at a second time, a packet data unit (PDU) indicating the less than all packets scheduled to be received at the first time, wherein the bit is set based obtaining the PDU.

Example 40 is the method of any of Examples 1-39, wherein the detected latency is further associated with a communication link between the wireless node and a distribution unit (DU).

Example 41 is the method of any of Examples 1-40, further comprising: modifying a communication parameter based on at least one of the detected latency or the bit being set.

Example 42 is the method of Example 41, wherein the communication parameter comprises an uplink data split threshold, and wherein the uplink data split threshold is modified to be overridden.

Example 43 is the method of any of Examples 41 and 42, wherein the communication parameter comprises a discard timer, and wherein the discard timer is modified to be overridden.

Example 44 is the method of any of Examples 41-43, wherein the communication parameter comprises a medium access control (MAC) policy parameter, and wherein the MAC policy parameter is modified to be overridden.

Example 45 is the method of Example 44, wherein the MAC policy parameter comprises a prioritized bit rate or a bucket size duration.

Example 46 is a method at a wireless node, comprising: detecting latency associated with a packet queued at the wireless node, the packet configured to be output for transmission via a first link; overriding an uplink data split threshold value associated with the packet; and outputting the packet via a second link after the override.

Example 47 is the method of Example 46, wherein the packet is configured to be communicated via a low latency, low loss, and scalable throughput (L4S) communication protocol, and wherein the override is based on at least one of the detected latency and the packet being communicated via L4S.

Example 48 is the method of any of Examples 46 and 47, wherein a bit is associated with an explicit congestion notification (ECN) field of the packet.

Example 49 is the method of any of Examples 46-48, wherein a bit is set at one or more of an internet protocol (IP) layer, a service data adaptation protocol (SDAP) layer, a packet data convergence protocol (PDCP) layer, a radio link control (RLC) layer, and a medium access control (MAC) layer.

Example 50 is the method of any of Examples 46-49, wherein the latency is detected based on a duration of time, which the packet spends in a queue, satisfying a threshold condition.

Example 51 is the method of any of Examples 46-50, further comprising: obtaining an indication of a quantity of packets delayed at a wireless node, wherein the latency is detected based on the quantity of packets satisfying a threshold condition.

Example 52 is the method of any of Examples 46-51, wherein the latency is detected based on a quantity of retransmissions of the packet satisfying a threshold condition.

Example 53 is the method of any of Examples 46-52, wherein the latency is detected based on one or more radio parameters of at least one link in a dual connectivity communication operation associated with the wireless node, wherein the packet was obtained or to be output for transmission via the link or another link associated with the link.

Example 54 is the method of Example 53, wherein the one or more radio parameters comprise at least one of: (i) a bandwidth difference between a first link and a second link, (ii) a carrier aggregation configuration, (iii) a quantity of receive antennas used for dual connectivity communication, or (iv) a bandwidth part configuration.

Example 55 is the method of any of Examples 53 and 54, wherein the latency is detected further based on at least one of a status trigger configuration or a polling trigger configuration of the at least one link of the dual connectivity communication.

Example 56 is the method of any of Examples 46-55, wherein the latency is detected based on PDCP out-of-order delivery of non-low latency, low loss, and scalable throughput (non-L4S) packets communicated via a link, and wherein the packet was obtained or to be output for transmission via the link or another link associated with the link.

Example 57 is the method of any of Examples 46-56, wherein the packet is communicated via a low latency, low loss, and scalable throughput (L4S) communication protocol.

Example 58 is the method of any of Examples 46-57, further comprising: overriding a reordering timer associated with the packet after a delay detection.

Example 59 is the method of any of Examples 46-58, further comprising: obtaining contiguous I-frames, wherein the latency is detected based on the obtained I-frames being contiguous, and wherein a first I-frame of the obtained I-frames comprises the packet, or the packet was obtained or to be output for transmission via a same link from which the I-frame was obtained, or the packet was obtained or to be output for transmission via a same radio bearer from which the I-frame was obtained.

Example 60 is the method of any of Examples 46-59, wherein the packet is part of a packet data unit (PDU) set.

Example 61 is the method of Example 60, wherein the latency is detected based on an indication that the packet was dropped in association with a PDU set integrity handling indication.

Example 62 is the method of any of Examples 46-61, wherein the packet is associated with a first data flow of a plurality of multi-modal data flows, wherein another packet is associated with a second data flow of the plurality of multi-modal data flows, and wherein the latency is detected based on a delay of the other packet.

Example 63 is the method of Example 62, wherein the latency is further based on the packet being stored in a reordering queue for a duration of time greater than or equal to a threshold value.

Example 64 is the method of any of Examples 46-63, wherein the latency is detected based on packet loss over an NR-U link, wherein the packet was obtained or is to be output for transmission via the NR-U link.

Example 65 is the method of any of Examples 46-64, further comprising: communicating signaling comprising a packet data convergence protocol (PDCP) bit or a control packet data unit (PDU) configured to indicate the detected latency.

Example 66 is the method of any of Examples 46-65, further comprising: obtaining signaling comprising a packet data convergence protocol (PDCP) bit or a control packet data unit (PDU) configured to indicate the detected latency, wherein the latency is detected based on the obtained signaling, and wherein the obtained signaling indicates a link from which the packet was obtained or is to be output for transmission, another link associated with the link from which the packet was obtained or is to be output for transmission, a radio bearer comprising the link, or another radio bearer associated with the radio bearer comprising the link.

Example 67 is the method of any of Examples 46-66, further comprising: monitoring at least one radio bearer used by the wireless node, wherein the detected latency is further associated with the at least one radio bearer, and wherein the packet was obtained or is to be output for transmission via the at least one radio bearer or another radio bearer associated with the at least one radio bearer.

Example 68 is the method of Example 67, wherein the latency is detected based on an aggregated latency associated with a plurality of radio bearers including the at least one radio bearer.

Example 69 is the method of Example 68, wherein each of the plurality of radio bearers are associated with a network service subscription.

Example 70 is the method of any of Examples 68 and 69, wherein each of the plurality of radio bearers are associated with a packet data network (PDN).

Example 71 is the method of any of Examples 67-70, further comprising: monitoring one or more queues associated with the at least one radio bearer, wherein the one or more queues are monitored based on whether a priority level associated with the queue satisfies a threshold condition.

Example 72 is the method of any of Examples 46-71, further comprising: monitoring at least one network service subscription used by the wireless node, wherein the detected latency is further associated with the at least one network service subscription, and wherein the packet was obtained or is to be output for transmission via a link associated with the at least one network service subscription.

Example 73 is the method of Example 72, wherein the detected latency is further associated at least one radio bearer associated with the at least one network service subscription.

Example 74 is the method of any of Examples 72 and 73, wherein the latency is detected based on an aggregated latency associated with a plurality of radio bearers of the at least one network service subscription.

Example 75 is the method of any of Examples 46-74, further comprising: monitoring one or more flows associated with an application server, wherein the detected latency is further associated with the one or more flows, and wherein the packet was obtained or is to be output for transmission via the at least one of the one or more flows.

Example 76 is the method of any of Examples 46-75, further comprising: outputting the packet for transmission after being queued; and obtaining a negative acknowledgment (NACK) associated with the packet, wherein the latency is detected further based on the obtained NACK.

Example 77 is the method of any of Examples 46-76, wherein the latency is detected based on the packet being held in a retransmission queue, and wherein a bit is set prior to retransmission.

Example 78 is the method of any of Examples 46-77, wherein the latency is detected based on a hybrid automatic repeat request (HARQ) block error rate (BLER) associated with the packet satisfying a threshold condition.

Example 79 is the method of any of Examples 46-78, wherein the latency is based on a configuration parameter, and wherein the method further comprises: overriding the configuration parameter after the latency is detected.

Example 80 is the method of Example 79, wherein the configuration parameter comprises at least one of: an uplink data split threshold value, a packet data convergence protocol (PDCP) discard timer, or a medium access control (MAC) logical channel prioritization (LCP) policy.

Example 81 is the method of any of Examples 46-80, further comprising: obtaining the packet at a first time, wherein the latency is detected based on receiving less than all packets scheduled to be received at the first time, and wherein the packet is part of the all packets scheduled to be received at the first time.

Example 82 is the method of Example 81, further comprising: obtaining, at a second time, one or more packets not previously obtained by the wireless node at the first time, wherein a bit is set based on the one or more packets being obtained.

Example 83 is the method of any of Examples 81 and 82, wherein a bit is set based an expiration of a reordering timer associated with the less than all packets scheduled to be received at the first time, wherein the timer operates at a packet data convergence protocol (PDCP) layer of the wireless node.

Example 84 is the method of any of Examples 81-83, further comprising: obtaining, at a second time, a packet data unit (PDU) indicating the less than all packets scheduled to be received at the first time, wherein a bit is set based obtaining the PDU.

Example 85 is the method of any of Examples 46-84, wherein the detected latency is further associated with a communication link between the wireless node and a distribution unit (DU).

Example 86 is the method of any of Examples 46-85, further comprising: modifying a communication parameter based on at least one of the detected latency or a bit being set.

Example 87 is the method of Example 86, wherein the communication parameter comprises an uplink data split threshold, and wherein the uplink data split threshold is modified to be overridden.

Example 88 is the method of any of Examples 86 and 87, wherein the communication parameter comprises a discard timer, and wherein the discard timer is modified to be overridden.

Example 89 is the method of any of Examples 86-88, wherein the communication parameter comprises a medium access control (MAC) policy parameter, and wherein the MAC policy parameter is modified to be overridden.

Example 90 is the method of Example 89, wherein the MAC policy parameter comprises a prioritized bit rate or a bucket size duration.

Example 91 is a method at a wireless node, comprising: detecting latency associated with a packet queued at the wireless node; setting a bit associated with the packet, wherein the bit is set to indicate the detected latency; and overriding a packet data convergence protocol (PDCP) discard timer associated with the packet, wherein the override is based on at least one of the detected latency and the bit being set.

Example 92 is the method of Example 91, wherein the packet is configured to be communicated via a low latency, low loss, and scalable throughput (L4S) communication protocol, and wherein the override is further based on the packet being configured to be communicated via L4S communication protocol.

Example 93 is the method of any of Examples 91 and 92, wherein the bit is associated with an explicit congestion notification (ECN) field of the packet.

Example 94 is the method of any of Examples 91-93, wherein the bit is set at one or more of an internet protocol (IP) layer, a service data adaptation protocol (SDAP) layer, a packet data convergence protocol (PDCP) layer, a radio link control (RLC) layer, and a medium access control (MAC) layer.

Example 95 is the method of any of Examples 91-94, wherein the latency is detected based on a duration of time, which the packet spends in a queue, satisfying a threshold condition.

Example 96 is the method of any of Examples 91-95, further comprising: obtaining an indication of a quantity of packets delayed at a wireless node, wherein the latency is detected based on the quantity of packets satisfying a threshold condition.

Example 97 is the method of any of Examples 91-96, wherein the latency is detected based on a quantity of retransmissions of the packet satisfying a threshold condition.

Example 98 is the method of any of Examples 91-97, wherein the latency is detected based on one or more radio parameters of at least one link in a dual connectivity communication operation associated with the wireless node, wherein the packet was obtained or to be output for transmission via the link or another link associated with the link.

Example 99 is the method of Example 98, wherein the one or more radio parameters comprise at least one of: (i) a bandwidth difference between a first link and a second link, (ii) a carrier aggregation configuration, (iii) a quantity of receive antennas used for dual connectivity communication, or (iv) a bandwidth part configuration.

Example 100 is the method of any of Examples 98 and 99, wherein the latency is detected further based on at least one of a status trigger configuration or a polling trigger configuration of the at least one link of the dual connectivity communication.

Example 101 is the method of any of Examples 91-100, wherein the latency is detected based on PDCP out-of-order delivery of non-low latency, low loss, and scalable throughput (non-L4S) packets communicated via a link, and wherein the packet was obtained or to be output for transmission via the link or another link associated with the link.

Example 102 is the method of any of Examples 91-101, wherein the packet is communicated via a low latency, low loss, and scalable throughput (L4S) communication protocol.

Example 103 is the method of any of Examples 91-102, further comprising: overriding a reordering timer associated with the packet after a delay detection.

Example 104 is the method of any of Examples 91-103, further comprising: obtaining contiguous I-frames, wherein the latency is detected based on the obtained I-frames being contiguous, and wherein a first I-frame of the obtained I-frames comprises the packet, or the packet was obtained or to be output for transmission via a same link from which the I-frame was obtained, or the packet was obtained or to be output for transmission via a same radio bearer from which the I-frame was obtained.

Example 105 is the method of any of Examples 91-104, wherein the packet is part of a packet data unit (PDU) set.

Example 106 is the method of Example 105, wherein the latency is detected based on an indication that the packet was dropped in association with a PDU set integrity handling indication.

Example 107 is the method of any of Examples 91-106, wherein the packet is associated with a first data flow of a plurality of multi-modal data flows, wherein another packet is associated with a second data flow of the plurality of multi-modal data flows, and wherein the latency is detected based on a delay of the other packet.

Example 108 is the method of Example 107, wherein the latency is further based on the packet being stored in a reordering queue for a duration of time greater than or equal to a threshold value.

Example 109 is the method of any of Examples 91-108, wherein the latency is detected based on packet loss over an NR-U link, wherein the packet was obtained or is to be output for transmission via the NR-U link.

Example 110 is the method of any of Examples 91-109, further comprising: communicating signaling comprising a packet data convergence protocol (PDCP) bit or a control packet data unit (PDU) configured to indicate the detected latency.

Example 111 is the method of any of Examples 91-110, further comprising: obtaining signaling comprising a packet data convergence protocol (PDCP) bit or a control packet data unit (PDU) configured to indicate the detected latency, wherein the latency is detected based on the obtained signaling, and wherein the obtained signaling indicates a link from which the packet was obtained or is to be output for transmission, another link associated with the link from which the packet was obtained or is to be output for transmission, a radio bearer comprising the link, or another radio bearer associated with the radio bearer comprising the link.

Example 112 is the method of any of Examples 91-111, further comprising: monitoring at least one radio bearer used by the wireless node, wherein the detected latency is further associated with the at least one radio bearer, and wherein the packet was obtained or is to be output for transmission via the at least one radio bearer or another radio bearer associated with the at least one radio bearer.

Example 113 is the method of Example 112, wherein the latency is detected based on an aggregated latency associated with a plurality of radio bearers including the at least one radio bearer.

Example 114 is the method of Example 113, wherein each of the plurality of radio bearers are associated with a network service subscription.

Example 115 is the method of any of Examples 113 and 114, wherein each of the plurality of radio bearers are associated with a packet data network (PDN).

Example 116 is the method of any of Examples 112-115, further comprising: monitoring one or more queues associated with the at least one radio bearer, wherein the one or more queues are monitored based on whether a priority level associated with the queue satisfies a threshold condition.

Example 117 is the method of any of Examples 91-116, further comprising: monitoring at least one network service subscription used by the wireless node, wherein the detected latency is further associated with the at least one network service subscription, and wherein the packet was obtained or is to be output for transmission via a link associated with the at least one network service subscription.

Example 118 is the method of Example 117, wherein the detected latency is further associated at least one radio bearer associated with the at least one network service subscription.

Example 119 is the method of any of Examples 117-118, wherein the latency is detected based on an aggregated latency associated with a plurality of radio bearers of the at least one network service subscription.

Example 120 is the method of any of Examples 91-119, further comprising: monitoring one or more flows associated with an application server, wherein the detected latency is further associated with the one or more flows, and wherein the packet was obtained or is to be output for transmission via the at least one of the one or more flows.

Example 121 is the method of any of Examples 91-120, further comprising: outputting the packet for transmission after being queued; and obtaining a negative acknowledgment (NACK) associated with the packet, wherein the latency is detected further based on the obtained NACK.

Example 122 is the method of any of Examples 91-121, wherein the latency is detected based on the packet being held in a retransmission queue, and wherein the bit is set prior to retransmission.

Example 123 is the method of any of Examples 91-122, wherein the latency is detected based on a hybrid automatic repeat request (HARQ) block error rate (BLER) associated with the packet satisfying a threshold condition.

Example 124 is the method of any of Examples 91-123, wherein the latency is based on a configuration parameter, and wherein the method further comprises: overriding the configuration parameter after the latency is detected.

Example 125 is the method of Example 124, wherein the configuration parameter comprises at least one of: an uplink data split threshold value, a packet data convergence protocol (PDCP) discard timer, or a medium access control (MAC) logical channel prioritization (LCP) policy.

Example 126 is the method of any of Examples 91-125, further comprising: obtaining the packet at a first time, wherein the latency is detected based on receiving less than all packets scheduled to be received at the first time, and wherein the packet is part of the all packets scheduled to be received at the first time.

Example 127 is the method of Example 126, further comprising: obtaining, at a second time, one or more packets not previously obtained by the wireless node at the first time, wherein the bit is set based on the one or more packets being obtained.

Example 128 is the method of any of Examples 126 and 127, wherein the bit is set based an expiration of a reordering timer associated with the less than all packets scheduled to be received at the first time, wherein the timer operates at a packet data convergence protocol (PDCP) layer of the wireless node.

Example 129 is the method of any of Examples 126-128, further comprising: obtaining, at a second time, a packet data unit (PDU) indicating the less than all packets scheduled to be received at the first time, wherein the bit is set based obtaining the PDU.

Example 130 is the method of any of Examples 91-129, wherein the detected latency is further associated with a communication link between the wireless node and a distribution unit (DU).

Example 131 is the method of any of Examples 91-130, further comprising: modifying a communication parameter based on at least one of the detected latency or the bit being set.

Example 132 is the method of Example 131, wherein the communication parameter comprises an uplink data split threshold, and wherein the uplink data split threshold is modified to be overridden.

Example 133 is the method of any of Examples 131 and 132, wherein the communication parameter comprises a discard timer, and wherein the discard timer is modified to be overridden.

Example 134 is the method of any of Examples 131-133, wherein the communication parameter comprises a medium access control (MAC) policy parameter, and wherein the MAC policy parameter is modified to be overridden.

Example 135 is the method of Example 134, wherein the MAC policy parameter comprises a prioritized bit rate or a bucket size duration.

Example 136 is an apparatus for wireless communications, comprising means for performing a method in accordance with any one of examples 1-45.

Example 137 is an apparatus for wireless communications, comprising means for performing a method in accordance with any one of examples 46-90.

Example 138 is an apparatus for wireless communications, comprising means for performing a method in accordance with any one of examples 91-135.

Example 139 is a non-transitory computer-readable medium comprising instructions that, when executed by a wireless node, cause the wireless node to perform a method in accordance with any one of examples 1-45.

Example 140 is a non-transitory computer-readable medium comprising instructions that, when executed by a wireless node, cause the wireless node to perform a method in accordance with any one of examples 46-90.

Example 141 is a non-transitory computer-readable medium comprising instructions that, when executed by a wireless node, cause the wireless node to perform a method in accordance with any one of examples 91-135.

Example 142 is an apparatus for wireless communications, comprising: one or more memories, individually or in combination, having instructions; and one or more processors, individually or in combination, configured to execute the instructions to cause the apparatus to perform a method in accordance with any one of examples 1-45.

Example 143 is an apparatus for wireless communications, comprising: one or more memories, individually or in combination, having instructions; and one or more processors, individually or in combination, configured to execute the instructions to cause the apparatus to perform a method in accordance with any one of examples 46-90.

Example 144 is an apparatus for wireless communications, comprising: one or more memories, individually or in combination, having instructions; and one or more processors, individually or in combination, configured to execute the instructions to cause the apparatus to perform a method in accordance with any one of examples 91-135.

Example 145 is a first wireless node (e.g., user equipment (UE) or a network entity), comprising: one or more transceivers; one or more memories, individually or in combination, having instructions; and one or more processors, individually or in combination, configured to execute the instructions to cause the wireless node to perform a method in accordance with any one of examples 1-45, wherein the one or more transceivers are configured to: communicate (e.g., transmit and receive) with a second wireless node.

Example 146 is a wireless node (e.g., user equipment (UE) or a network entity), comprising: one or more transceivers; one or more memories, individually or in combination, having instructions; and one or more processors, individually or in combination, configured to execute the instructions to cause the wireless node to perform a method in accordance with any one of examples 46-90, wherein the one or more transceivers are configured to: transmit the packet via the second link after the override.

Example 147 is a first wireless node (e.g., user equipment (UE) or a network entity), comprising: one or more transceivers; one or more memories, individually or in combination, having instructions; and one or more processors, individually or in combination, configured to execute the instructions to cause the wireless node to perform a method in accordance with any one of examples 91-135, wherein the one or more transceivers are configured to: communicate (e.g., transmit and receive) with a second wireless node.

What is claimed is:

1. An apparatus for wireless communication, comprising:
one or more memories, individually or in combination, having instructions; and
one or more processors, individually or in combination, configured to execute the instructions and cause the apparatus to:
detect latency associated with a packet queued at the apparatus; and
set a bit associated with the packet, wherein the bit is set to indicate the detected latency.

2. The apparatus of claim 1, wherein the bit is associated with an explicit congestion notification (ECN) field of the packet.

3. The apparatus of claim 1, wherein the bit is set at one or more of: an application processor, an interconnect coupled to a modem and the application processor, and a packet data convergence protocol (PDCP) layer.

4. The apparatus of claim 1, wherein the bit is set at one or more of an internet protocol (IP) layer, a service data adaptation protocol (SDAP) layer, a packet data convergence protocol (PDCP) layer, a radio link control (RLC) layer, and a medium access control (MAC) layer.

5. The apparatus of claim 1, wherein the latency is detected based on at least one of: a duration of time during which the packet spends in a queue satisfying a threshold condition, an indication that the packet was dropped in association with a PDU set integrity handling indication, a quantity of retransmissions of the packet satisfying a threshold condition, the packet being held in a retransmission queue, or a negative acknowledgment (NACK) associated with the packet.

6. The apparatus of claim 1, wherein the one or more processors, individually or in combination, are further configured to cause the apparatus to:
obtain an indication of a quantity of packets delayed at a wireless node, wherein the latency is detected based on the quantity of packets satisfying a threshold condition.

7. The apparatus of claim 1, wherein the latency is detected based on one or more radio parameters of at least one link in a dual connectivity communication operation associated with the apparatus, wherein the packet was obtained or to be output for transmission via the at least one link.

8. The apparatus of claim 7, wherein at least one of:
the one or more radio parameters comprise at least one of: (i) a bandwidth difference between a first link and a second link, (ii) a carrier aggregation configuration, (iii) a quantity of receive antennas used for dual connectivity communication, or (iv) a bandwidth part configuration, or
the latency is detected further based on at least one of a status trigger configuration or a polling trigger configuration of the at least one link of the dual connectivity communication.

9. The apparatus of claim 1, wherein the one or more processors, individually or in combination, are further configured to cause the apparatus to:
monitor at least one radio bearer used by the apparatus, wherein the detected latency is further associated with the at least one radio bearer, wherein the packet was obtained or is to be output for transmission via the at least one radio bearer or another radio bearer associated with the at least one radio bearer, and wherein at least one of:
the latency is detected based on an aggregated latency associated with a plurality of radio bearers including the at least one radio bearer,
each of the plurality of radio bearers are associated with a network service subscription, or
each of the plurality of radio bearers are associated with a packet data network (PDN).

10. The apparatus of claim 1, wherein the one or more processors, individually or in combination, are further configured to cause the apparatus to:
monitor at least one network service subscription used by the apparatus, wherein the detected latency is further associated with the at least one network service subscription, wherein the packet was obtained or is to be output for transmission via a link associated with the at least one network service subscription, and wherein at least one of:
the detected latency is further associated at least one radio bearer associated with the at least one network service subscription, or
the latency is detected based on an aggregated latency associated with a plurality of radio bearers of the at least one network service subscription.

11. The apparatus of claim 1, wherein the latency is based on a configuration parameter, and wherein the one or more processors, individually or in combination, are further configured to cause the apparatus to:
override the configuration parameter after the latency is detected, wherein the configuration parameter comprises at least one of: an uplink data split threshold value, a packet data convergence protocol (PDCP) discard timer, or a medium access control (MAC) logical channel prioritization (LCP) policy.

12. The apparatus of claim 1, wherein the packet is associated with a first data flow of a plurality of multi-modal data flows, wherein another packet is associated with a second data flow of the plurality of multi-modal data flows, and wherein the latency is detected based on a delay of the other packet.

13. The apparatus of claim 12, wherein the latency is further based on the packet being stored in a reordering queue for a duration of time greater than or equal to a threshold value.

14. The apparatus of claim 1, wherein the one or more processors, individually or in combination, are further configured to cause the apparatus to:
obtain the packet at a first time, wherein the latency is detected based on receiving less than all packets scheduled to be received at the first time, and wherein the packet is part of the all packets scheduled to be received at the first time; and
obtain, at a second time, one or more packets not previously obtained by the apparatus at the first time, wherein the bit is set based on the one or more packets being obtained.

15. The apparatus of claim 14, wherein the bit is set based an expiration of a reordering timer associated with the less than all packets scheduled to be received at the first time, wherein the timer operates at a packet data convergence protocol (PDCP) layer of the apparatus.

16. The apparatus of claim 1, wherein the one or more processors, individually or in combination, are further configured to cause the apparatus to:
modify a communication parameter based on at least one of the detected latency or the bit being set, and wherein at least one of:
the communication parameter comprises an uplink data split threshold, and wherein the uplink data split threshold is modified to be overridden,
the communication parameter comprises a discard timer, and wherein the discard timer is modified to be overridden, or
the communication parameter comprises a medium access control (MAC) policy parameter, and wherein the MAC policy parameter is modified to be overridden.

17. The apparatus of claim 1, wherein the latency is detected based on packet loss over an NR-U link, wherein the packet was obtained or is to be output for transmission via the NR-U link.

18. An apparatus for wireless communication, comprising:
one or more memories, individually or in combination, having instructions; and
one or more processors, individually or in combination, configured to execute the instructions and cause the apparatus to:
detect latency associated with a packet queued at the apparatus, the packet configured to be output for transmission via a first link;
override an uplink data split threshold value associated with the packet; and
output the packet via a second link after the override.

19. The apparatus of claim 18, wherein the packet is configured to be communicated via a low latency, low loss, and scalable throughput (LAS) communication protocol, and wherein the override is based on at least one of the detected latency and the packet being communicated via LAS.

20. An apparatus for wireless communication, comprising:
one or more memories, individually or in combination, having instructions; and
one or more processors, individually or in combination, configured to execute the instructions and cause the apparatus to:
detect latency associated with a packet queued at the apparatus;
set a bit associated with the packet, wherein the bit is set to indicate the detected latency; and
override, based on at least one of the detected latency or the bit being set, at least one of: (i) an uplink data split threshold value associated with the packet, or (ii) a packet data convergence protocol (PDCP) discard timer associated with the packet.
